(19) United States
(12) Patent Application Publication
(10) Pub. No.: US 2025/0124782 A1
(43) Pub. Date: Apr. 17, 2025

(54) DATA PROCESSING METHOD, APPARATUS, COMPUTER DEVICE, AND READABLE STORAGE MEDIUM

(71) Applicant: Tencent Technology (Shenzhen) Company Limited, Shenzhen (CN)

(72) Inventor: Siyang LIU, Shenzhen (CN)

(73) Assignee: Tencent Technology (Shenzhen) Company Limited, Shenzhen (CN)

(21) Appl. No.: 18/999,313

(22) Filed: Dec. 23, 2024

Related U.S. Application Data
(63) Continuation of application No. PCT/CN2023/103100, filed on Jun. 28, 2023.

(30) Foreign Application Priority Data
Jul. 6, 2022 (CN) 202210789200.4

(51) Int. Cl. G08G 1/01; G06F 11/34; G06F 11/3668

(52) U.S. Cl. CPC G08G 1/0116; G06F 11/3452; G06F 11/3668

(57) ABSTRACT

A data processing method and apparatus including obtaining baseline performance information of a road side sensing device, the baseline performance information representing a sensing capability of the road side sensing device, and the road side sensing device being located in a road side area covered by the road side communication device, obtaining road side sensing data generated by the road side sensing device, and transmitting the road side sensing data and the baseline performance information to an on board terminal located in the road side area such that the on board terminal adjusts the road side sensing data based on the baseline performance information.

### CROSS-REFERENCE TO RELATED APPLICATIONS

This application is a continuation application of International Application No. PCT/CN2023/103100 filed on Jun. 28, 2023 which claims priority to Chinese Patent Application No. 202210789200.4 filed with the China National Intellectual Property Administration on Jul. 6, 2022, the disclosures of each being incorporated by reference herein in their entireties.

### FIELD

The disclosure relates to the field of vehicular communication technologies, and in particular, to a data processing method and apparatus, a computer device, and a readable storage medium.

### BACKGROUND

With the development of vehicle intelligence and networking technologies, the vehicle to everything (V2X) communication technology shows growing importance, and has become one of the supporting technologies of smart vehicles and smart traffic. In the related art, a road side sensing device can send sensed road side sensing data (for example, a position and a location confidence of a traffic participant) to a road side communication device, so that the road side communication device forwards the road side sensing data to an on board terminal. In this way, the on board terminal can directly use the road side sensing data forwarded by the road side communication device.

### SUMMARY

Some embodiments provide a data processing method, performed by a road side communication device, including: obtaining baseline performance information of a road side sensing device, the baseline performance information representing a sensing capability of the road side sensing device, and the road side sensing device being located in a road side area covered by the road side communication device; obtaining road side sensing data generated by the road side sensing device; and transmitting the road side sensing data and the baseline performance information to an on board terminal located in the road side area such that the on board terminal adjusts the road side sensing data based on the baseline performance information.

Some embodiments provide a data processing apparatus, including: at least one memory configured to store program code; and at least one processor configured to read the program code and operate as instructed by the program code, the program code comprising: obtaining code configured to cause at least one of the at least one processor to: obtain baseline performance information of a road side sensing device, the baseline performance information representing a sensing capability of the road side sensing device, and the road side sensing device being located in a road side area covered by a road side communication device, and obtain road side sensing data generated by the road side sensing device; and transmission code configured to cause at least one of the at least one processor to transmit the road side sensing data and the baseline performance information to an on board terminal located in the road side area such that the on board terminal adjusts the road side sensing data based on the baseline performance information.

Some embodiments provide a non-transitory computer-readable storage medium storing computer code which, when executed by at least one processor, causes the at least one processor to at least: obtain baseline performance information of a road side sensing device, the baseline performance information representing a sensing capability of the road side sensing device, and the road side sensing device being located in a road side area covered by the road side communication device; obtain road side sensing data generated by the road side sensing device; and transmit the road side sensing data and the baseline performance information to an on board terminal located in the road side area such that the on board terminal adjusts the road side sensing data based on the baseline performance information

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic structural diagram of a network architecture according to some embodiments.

FIG. 2 is a schematic diagram of a scenario of data interaction according to some embodiments.

FIG. 3 is a schematic flowchart of a data processing method according to some embodiments.

FIG. 4 is a schematic diagram of a scenario of generating baseline performance information according to some embodiments.

FIG. 5A is a schematic diagram of a scenario of message interaction according to some embodiments.

FIG. 5B is a schematic diagram of a scenario of message interaction according to some embodiments.

FIG. 6 is a schematic flowchart of a data processing method according to some embodiments.

FIG. 7 is a schematic diagram of a scenario of downgrading according to some embodiments.

FIG. 8 is a schematic diagram of a scenario of confidence filtering according to some embodiments.

FIG. 9 is a schematic flowchart of a data processing method according to some embodiments.

FIG. 10A is a schematic diagram of a scenario of information exchange according to some embodiments.

FIG. 10B is a schematic diagram of a scenario of information exchange according to some embodiments.

FIG. 11 is a schematic diagram of a scenario of data processing according to some embodiments.

FIG. 12 is a schematic structural diagram of a data processing apparatus according to some embodiments.

FIG. 13 is a schematic structural diagram of a data processing apparatus according to some embodiments.

FIG. 14 is a schematic structural diagram of a computer device according to some embodiments.

FIG. 15 is a schematic structural diagram of a data processing system according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The following clearly and completely describes the technical solutions of various embodiments with reference to the accompanying drawings.

The technical solution of various embodiments may be applied to a vehicular communication system, for example, a vehicle to everything (V2X) system based on a cellular network communication technology (namely, Cellular Vehicle to Everything, C-V2X for short). The C-V2X includes LTE-V2X (long term evolution, LTE for short) based on the 4th generation mobile communication technology (4G for short), and 5G-V2X (also referred to as NR-V2X, New Radio, NR for short) based on the 5th generation mobile communication technology (5G for short). In addition, from a perspective of technology evolution, the LTE-V2X supports smooth evolution towards the 5G-V2X.

V2X systems may be used in various communication scenarios including, but not limited to, vehicle-to-vehicle (V2V), vehicle-to-infrastructure (V2I), vehicle-to-pedestrian (V2P), vehicle-to-network (V2N), and the like.

An intelligent traffic system (ITS), also referred to as intelligent transportation system, is an integrated transportation system that effectively integrates advanced scientific technologies (information technology, computer technology, data communication technology, sensor technology, electronic control technology, theory of automatic control, operations research, artificial intelligence, and the like) for transportation, service control, and vehicle manufacture, and enhances the connection between vehicles, roads, and users, thereby ensuring safety, improving efficiency, improving environment, and saving energy.

An intelligent vehicle infrastructure cooperative system (IVICS), vehicle infrastructure cooperative system for short, is one direction of development of the intelligent traffic system (ITS). The vehicle infrastructure cooperative system is a safe, efficient, and environmentally friendly road traffic system that adopts advanced technologies such as wireless communication and new generation internet, implements comprehensive dynamic real-time information interaction between vehicles and between vehicle and road, and performs active vehicle safety control and road cooperative management on the basis of full space-time dynamic traffic information collection and fusion, to fully realize effective cooperation of pedestrians, vehicles, and roads, ensure traffic safety, and improve traffic efficiency.

There are a variety of device types for the road side sensing device, and sensing algorithms used by the road side sensing devices are widely different, and manners used by the road side sensing devices to calculate the road side sensing data are different. In other words, different road side sensing devices may generate road side sensing data with different accuracies, causing the on board terminal to indiscriminately use the road side sensing data with different accuracies after receiving the road side sensing data. Consequently, the on board terminal cannot ensure reliability of processing results obtained based on the road side sensing data.

Various embodiments provide a data processing method and apparatus, a computer device, and a readable storage medium, which can improve an accuracy of a processing result obtained based on road side sensing data.

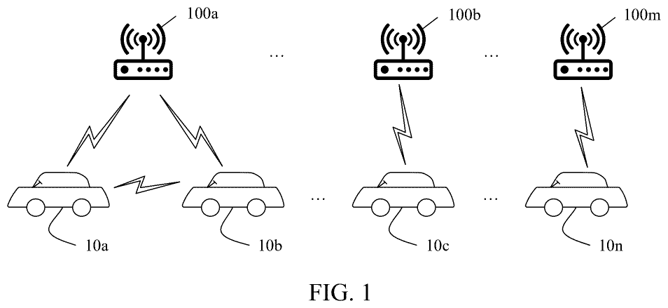

FIG. 1 is a schematic structural diagram of a network architecture applicable to the data processing method provided in some embodiments. As shown in FIG. 1, the network architecture may include a road side communication device cluster and an on board terminal cluster. The road side communication device cluster may specifically include one or more road side communication devices. The number of road side communication devices in the road side communication device cluster is not limited herein. As shown in FIG. 1, a plurality of road side communication devices may include a road side communication device 100a, a road side communication device 100b, . . . , and a road side communication device 100m. There may be communication connections between the road side communication device 100a, the road side communication device 100b, . . . , and the road side communication device 100m to implement information interaction. For example, there may be a communication connection between the road side communication device 100a and the road side communication device 100b.

The road side communication device in some embodiments may be a communication device (or a communication gateway) deployed on a road side. In some embodiments, the road side communication device may be deployed based on information such as a road environment and a service requirement. In the V2X system, the road side communication device may be a road side unit (RSU). The road side unit is a hardware unit that is installed on the road side and that enables V2X communication and supports V2X applications.

The road side communication device may communicate with a road side traffic infrastructure to collect information such as a current road status and a traffic status, and may deliver peripheral traffic information (for example, in a broadcast manner) to a road traffic participant (for example, an on board terminal within a signal coverage area of the road side communication device), to realize functions of vehicle-road interworking, real-time traffic signal interaction, assisting drivers to drive, and safeguarding persons and vehicles in the entire traffic area. The road side traffic infrastructure may include terminals such as road side sensing devices (for example, cameras, millimeter wave radars, and LIDAR's), traffic lights, and electronic signs. A sensor type and a number of sensors of the road side sensing device are not limited herein.

The on board terminal cluster may include one or more on board terminals. The number of on board terminals in the on board terminal cluster is not limited herein. As shown in FIG. 1, a plurality of on board terminals may specifically include an on board terminal 10a, an on board terminal 10b, an on board terminal 10c, . . . , and an on board terminal 10n. There may be communication connections between the on board terminal 10a, the on board terminal 10b, the on board terminal 10c, . . . , and the on board terminal 10n to enable information interaction. For example, there may be a communication connection between the on board terminal 10a and the on board terminal 10b.

Each on board terminal of the on board terminal cluster may be an intelligent driving vehicle, or may be an autonomous driving vehicle of different levels. In addition, vehicle types of each on board terminal include but are not limited to a small-sized vehicle, a medium-sized vehicle, a large-sized vehicle, a cargo vehicle, an ambulance, a fire truck, and the like. The vehicle type of the on board terminal is not limited in some embodiments.

Each on board terminal may include an on board sensing device (such as a camera, a millimeter wave radar, or a LIDAR) and an on board communication device. In the V2X system, the on board communication device may be an on board unit (OBU). The on board unit is a hardware unit that is installed on a vehicle and that enables V2X communication and supports V2X applications. A sensor type and a number of sensors of the on board sensing device are not limited herein.

Each road side communication device corresponds to a coverage area due to a difference in signal coverage, and each road side communication device may perform information interaction with on board terminals within its coverage area. As shown in FIG. 1, on board terminals within a coverage area of the road side communication device 100a may include the on board terminal 10a and the on board terminal 10b, and therefore, the road side communication device 100a may implement information interaction with the on board terminal 10a and the on board terminal 10b. On board terminals within a coverage area of the road side communication device 100b may include the on board terminal 10c, and therefore, the road side communication device 100b may implement information interaction with the on board terminal 10c. On board terminals within a coverage area of the road side communication device 100m may include the on board terminal 10n, and therefore, the road side communication device 100m may implement information interaction with the on board terminal 10n. Similarly, each road side communication device may implement information interaction with a road side sensing device within its coverage area. Road side sensing devices with coverage areas of all road side communication devices are not shown in FIG. 1.

Positions of the on board terminals may constantly change, and therefore, on board terminals covered by a road side communication device at different moments are different. For example, at a T1 moment, the on board terminals within the coverage area of the road side communication device 100a may include the on board terminal 10a and the on board terminal 10b; and at a T2 moment, the on board terminals in the coverage area of the road side communication device 100a may include the on board terminal 10c, where the T2 moment herein may be a moment next to the T1 moment.

In addition, deployment of the road side communication devices is very flexible due to the diversity of actual road environments. When the road side communication devices are densely deployed on the road side, the coverage areas of the road side communication devices may overlap, and an on board terminal located in an overlapping area may communicate with a plurality of road side communication devices. For example, if the coverage areas of the road side communication device 100a and the road side communication device 100b overlap, and the on board terminal 10a is the on board terminal in the overlapping area, the on board terminal 10a may communicate with both the road side communication device 100a and the road side communication device 100b. For example, the on board terminal in the overlapping area may choose to communicate with a road side communication device closest in distance. Similarly, a road side sensing device located in the overlapping area may communicate with a plurality of road side communication devices. For example, the road side sensing device in the overlapping area may choose to communicate with a road side communication device closest in distance.

The road side communication device and the road side sensing device may be collectively referred to as a road side system, and a vehicle side communication device and a vehicle side sensing device in the on board terminal may be collectively referred to as a vehicle side system (namely, a vehicle system). The road side system may broadcast sensed road side sensing data to the vehicle side system based on road side traffic messages (for example, road safety messages (RSM), road side information (RSI), and signal status messages (SSM)), so that the vehicle side system can implement functions of over-the-sight sensing, blind spot sensing, efficient acquisition of dynamic road information, and the like based on the road side sensing data and vehicle side sensing data sensed by the vehicle, thereby improving driving safety.

The road side sensing data and the vehicle side sensing data each are sensing data of a sensing object (for example, a traffic participant (such as a motor vehicle, a non-motor vehicle, or a pedestrian), a traffic event (such as a car accident, a construction area, a special road condition (such as foggy, icy, or slippery), or a dangerous road), or a traffic obstruction (such as a stone or a plastic bottle)). The road side sensing data and the vehicle side sensing data may include the same sensed sensing object or may include different sensed sensing objects. For ease of understanding, in some embodiments, a sensing object sensed by the road side sensing device may be referred to as a road side sensing object, and a sensing object sensed by the vehicle side sensing device may be referred to as a vehicle side sensing object.

When broadcasting the road side traffic message, the road side system needs to set a confidence indicator in the road side traffic message in order for the vehicle side system to obtain confidence of the road side system in the sent sensing object, so that the vehicle side system can better fuse the road side sensing data and the vehicle side sensing data based on a confidence (namely, a sensing confidence) sent by the road side system. The confidence, also referred to as a confidence level, reliability, or a confidence coefficient, represents a probability that an estimated value is within an allowable error range from an overall parameter.

The road side system needs to send (for example, in a broadcast manner) baseline performance information (namely, sensing baseline performance information) for the road side sensing device to the vehicle side system. The baseline performance information is generated based on a test scenario provided by a certification authority, and may be configured for representing a sensing capability of the road side sensing device. The certification authority is a third party authority agency (namely, an authoritative testing agency) that can define the test scenario according to an industry standard, and the road side sensing device needs to be tested by the third party authority agency. The road side sensing device may send the baseline performance information to the vehicle side system through the road side communication device after generating the baseline performance information. Optionally, the third party agency may send the baseline performance information to the vehicle side system through the road side communication device after generating the baseline performance information.

Therefore, after receiving the baseline performance information, the vehicle side system may determine whether to adjust the road side sensing data based on the baseline performance information. If the baseline performance information indicates that the road side sensing data needs to be adjusted, the vehicle side system may fuse adjusted road side sensing data and the vehicle side sensing data to realize the foregoing function; or if the baseline performance information indicates that the road side sensing data does not need to be adjusted, the vehicle side system directly fuses the road side sensing data and the vehicle side sensing data to realize the foregoing function.

The road side sensing device may sense road side sensing data within its coverage are, and the vehicle side sensing device may sense vehicle side sensing data within its coverage area. For ease of understanding, in some embodiments, the coverage area of the road side communication device may be referred to as a road side area, the coverage area of a road side sensing device may be referred to as a road side sensing area, and the coverage area of the vehicle side sensing device may be referred to as a vehicle side area (namely, a vehicle side sensing area).

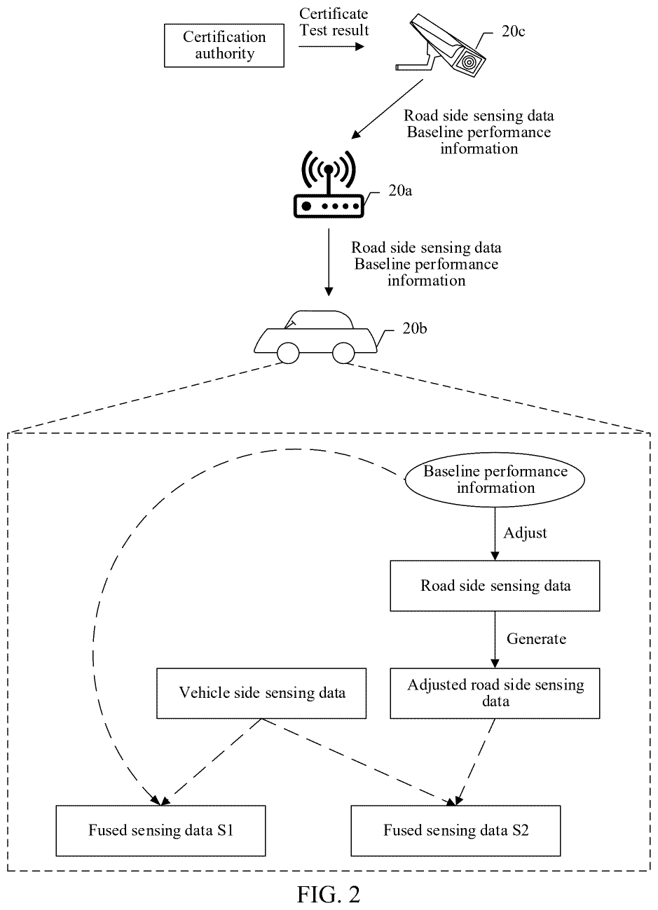

For ease of understanding, one road side communication device may be selected from the plurality of road side communication devices shown in FIG. 1 as a target road side communication device. For example, in some embodiments, the road side communication device 100a shown in FIG. 1 is used as the target road side communication device. For ease of understanding, one on board terminal may be selected from a plurality of on board terminals within the coverage area of the target road side communication device shown in FIG. 1 as a target on board terminal. For example, in some embodiments, the on board terminal 10a shown in FIG. 1 is used as the target on board terminal. For a process of data interaction between the target road side communication device and the target on board terminal, refer to the following descriptions of the embodiment corresponding to FIG. 2.

FIG. 2 is a schematic diagram of a scenario of data interaction according to some embodiments. A road side communication device 20a shown in FIG. 2 may be the foregoing target road side communication device in the embodiment corresponding to FIG. 1, an on board terminal 20b shown in FIG. 2 may be the foregoing target on board terminal in the embodiment corresponding to FIG. 1, a road side sensing device 20c shown in FIG. 2 may be a road side sensing device within a coverage area of the road side communication device 20a, the on board terminal 20b may be an on board terminal within a coverage area of the road side communication device 20a, and the road side sensing device 20c herein may be a camera.

As shown in FIG. 2, a certification authority may provide a test scenario (the number of test scenarios may be one or more), and the road side sensing device 20c may perform device certification based on the test scenario. If the road side sensing device 20c passes the test of the certification authority, the certification authority may issue a certificate to the road side sensing device 20c, and reply the road side sensing device 20c with a test result corresponding to the test scenario, where the test result herein may be a test pass result. In one embodiment, if the road side sensing device 20c fails the test of the certification authority, the certification authority does not need to issue a certificate to the road side sensing device 20c, and replies the road side sensing device 20c with a test result corresponding to the test scenario, where the test result herein may be a test fail result.

When there is one test scenario, the test pass result may indicate that the road side sensing device 20c passes a test of the test scenario; or when there are a plurality of test scenarios, the test pass result may indicate that the road side sensing device 20c passes tests of the plurality of test scenarios. Similarly, when there is one test scenario, the test fail result may indicate that the road side sensing device 20c fails a test of the test scenario; or when there are a plurality of test scenarios, the test fail result may indicate that the road side sensing device 20c fails tests of all the plurality of test scenarios or fails tests of some test scenarios.

As shown in FIG. 2, the road side sensing device 20c may generate baseline performance information corresponding to the road side sensing device 20c based on the certificate and the test pass result, and then send the baseline performance information to the road side communication device 20a. In one embodiment, the road side sensing device 20c may generate baseline performance information corresponding to the road side sensing device 20c based on the certificate and the test fail result, and then send the baseline performance information to the road side communication device 20a. The road side sensing device 20c may sense a road side sensing object within its coverage area (namely, a road side sensing area) by using a sensor carried by the road side sensing device 20c, generate road side sensing data of the road side sensing object, and then send the road side sensing data to the road side communication device 20a.

As shown in FIG. 2, after receiving the baseline performance information, the road side communication device 20a may forward the baseline performance information to the on board terminal 20b; and after receiving the road side sensing data, the road side communication device 20a may forward the road side sensing data to the on board terminal 20b. The road side communication device 20a may forward the baseline performance information and the road side sensing data separately or simultaneously, and this is not limited herein.

The baseline performance information may be configured for representing a sensing capability of the road side sensing device 20c, and the road side sensing data may represent sensing data sensed by the road side sensing device 20c within its sensing capability. Therefore, after receiving the baseline performance information and the road side sensing data, the on board terminal 20b may perform information verification on the baseline performance information, obtain a verification result, and then adjust the road side sensing data based on the verification result. The on board terminal 20b may sense a vehicle side sensing object within its coverage area (namely, a vehicle side sensing area) by using a sensor carried by the on board terminal 20b, and generate vehicle side sensing data of the vehicle side sensing object.

If the verification result indicates that the verification is passed, the on board terminal 20b may fuse the vehicle side sensing data and the road side sensing data to obtain fused sensing data S1, and then perform a driving policy for the fused sensing data S1. In some embodiments, if the verification result indicates that the verification is not passed, the on board terminal 20b may adjust the road side sensing data to obtain adjusted road side sensing data, fuse the vehicle side sensing data and the adjusted road side sensing data to obtain fused sensing data S2, and then perform a driving policy for the fused sensing data S2.

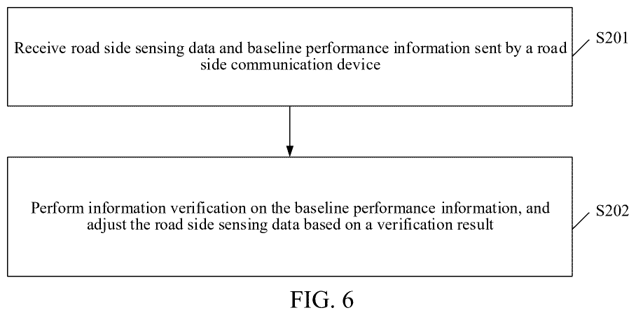

The baseline performance information generated based on the certificate and the test fail result indicates that the verification is not passed, and the baseline performance information generated based on the certificate and the test pass result may indicate that the verification is passed or may indicate that the verification is not passed. For a specific process in which the on board terminal 20b performs information verification on the baseline performance information, refer to the following descriptions of operation S202 in the embodiment corresponding to FIG. 6.

It can be seen that, some embodiments support the road side communication device to send the baseline performance information of the road side sensing device and the road side sensing data to the on board terminal. Because the baseline performance information can be configured for representing sensing capabilities of different road side sensing devices, after receiving the baseline performance information and the road side sensing data, the on board terminal can adjust the road side sensing data generated by the different road side sensing devices based on the sensing capabilities of the different road side sensing devices. In this way, when the adjusted road side sensing data is processed, an accuracy of a processing result is improved, in other words, an accuracy of a processing result obtained based on the road side sensing data is improved.

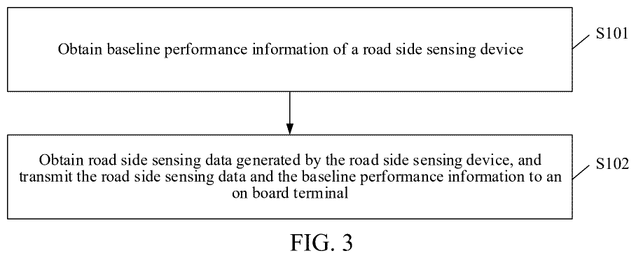

FIG. 3 is a schematic flowchart of a data processing method according to some embodiments. The method may be performed by a road side communication device, may be performed by an on board terminal, or may be jointly performed by a road side communication device and an on board terminal. The road side communication device may be the foregoing road side communication device 20a in the embodiment corresponding to FIG. 2, and the on board terminal may be the foregoing on board terminal 20b in the embodiment corresponding to FIG. 2. In some embodiments the method is performed by a road side communication device. The data processing method may include the following operations:

S101: Obtain baseline performance information of a road side sensing device.

The baseline performance information may be configured for representing a sensing capability of the road side sensing device for a sensing object, and the road side sensing device is located in a road side area covered by the road side communication device. The baseline performance information is generated by the road side sensing device based on a test scenario provided by a certification authority, and the baseline performance information includes at least one of test pass information, test certificate information, a test certification scenario, or a test certification level. The test pass information is configured for representing a test passing status of the road side sensing device, to be specific, is configured for representing whether the road side sensing device passes a test in the test scenario; the test certificate information is configured for representing a certificate number provided by the certification authority for the road side sensing device; the test certification scenario is configured for representing the test scenario; and the test certification level is configured for representing a level of the sensing capability of the road side sensing device in the test scenario. One test certification scenario corresponds to one test certification level, and test certification levels corresponding to test certification scenarios may be the same or may be different. A number of test scenarios is not limited herein.

In some embodiments, the baseline performance information includes the test pass information, the test certificate information, the test certification scenario, and the test certification level. Table 1 shows a format of information included in the baseline performance information according to some embodiments. A field name associated with the road side sensing device and descriptions corresponding to the field name may be stored in the baseline performance information. As shown in Table 1:

TABLE 1

| Field name | Descriptions |
|---|---|
| Test pass | Whether a sensing system passes a test of an |
| information | authority agency |
| Test certificate | Certificate number of the sensing system at the |
| information | authoritative testing authority |
| Test certification | Scenario 1, scenario 2, scenario 3, . . . |
| scenario | |
| Test certification | Level 1, level 2, level 3, . . . in the test |
| level | certification scenarios |

Note:
In the road side sensing baseline performance information, relevant performance indicators of the road side sensing system in a plurality of test scenarios may be provided.

The test pass information may be added to a test pass field, the test certificate information may be added to a test certificate field, the test certification scenario may be added to a certification scenario field, and the test certification level may be added to a test level field. In some embodiments, because the test pass information and the test certificate information may represent the same meaning, the test pass information or the test certificate information may be used as the baseline performance information.

The test passing status indicates whether the sensing system passes the test of the authority agency, and the test passing status may be that the test is passed and that the test is not passed. If the certification authority issues a certificate for the road side sensing device, it indicates that the test is passed; or if the certification authority does not issue a certificate for the road side sensing device, it indicates that the test is not passed. The test certificate information may be a certificate number of the certificate issued by the certification authority (namely, the authoritative testing authority) for the road side sensing device.

A granularity of division of test certification scenarios are not limited herein. For example, the test certification scenarios may be divided into high speed roads, urban roads, country roads, and the like. For another example, the test certification scenarios may be divided into urban roads (daytime), high speed roads (daytime), urban roads (nighttime), high speed roads (nighttime), and the like. For another example, the test authentication scenarios may be divided into fast ways, trunk ways, secondary trunk ways, branch ways, and the like. For another example, the test certification scenarios may be divided into sunny days, rainy days (heavy rain, light rain, and the like), overcast days, and the like.

The test certification level is determined by the certification authority based on a measured confidence of the road side sensing device; the measured confidence is determined by the certification authority based on target sensing data and test sensing data transmitted by the road side sensing device; the target sensing data is actual sensing data corresponding to a test object in the test scenario; and the test sensing data is sensing data corresponding to the test object sensed by the road side sensing device in the test scenario. The measured confidence can be an error between the target sensing data and the test sensing data; or the measured confidence is determined based on an error of the target sensing data and the test sensing data. In this case, the road side sensing device may calculate the test sensing data for the test object for a plurality of times, and send the plural pieces of test sensing data to the certification authority, so that the certification authority can generate a plurality of errors based on the target sensing data and the plural pieces of test sensing data, and determine the measured confidence based on the plurality of errors. The certification authority may determine that a probability (for example, 95%, where a specific value is not limited) corresponding to the plurality of errors meets a probability threshold, where the probability threshold herein represents that the measured confidence is at a confidence level of the probability. The probability corresponding to the plurality of errors is equal to a ratio of a number of errors meeting the corresponding threshold to a total number of errors. For example, a threshold for a position corresponding to the sensing object is 1 meter. If there are 100 errors between a target position and a test position, and 95 of the 100 errors are within 1 meter, a probability corresponding to the plurality of errors is equal to 95%. When the target sensing data and the test sensing data include positions, the target sensing data may represent a target position of the test object, and the test sensing data may be a test position of the test object sensed by the road side sensing device. In this case, the measured confidence (namely, a measured position confidence) may represent an error between the target position and the test position; or the measured confidence (namely, the measured position confidence) is determined based on an error between the target position and the test position. In other words, the target position and the test position may have 100 errors, and if 95 of the 100 errors are within 1 meter, the measured position confidence may be determined to be 1 meter with a 95% confidence level.

Test objects may include, but are not limited to, a traffic participant, a traffic obstruction, and a traffic event. If the test object is a traffic participant, test sensing data of the traffic participant may include, but is not limited to, a test position, a test speed, a test heading angle, a test size, and a test type. Therefore, the measured confidence may include, but is not limited to, a measured position confidence, a measured speed confidence, a measured heading angle confidence, a measured size confidence, and a measured type confidence. If the test object is a traffic obstruction, test sensing data of the traffic obstruction may include, but is not limited to, a test position, a test speed, a test heading angle, a test size, and a test type. Therefore, the measured confidence may include, but is not limited to, a measured position confidence, a measured speed confidence, a measured heading angle confidence, a measured size confidence, and a measured type confidence. If the test object is a traffic event, test sensing data of the traffic event may include, but is not limited to, a test event. Therefore, the measured confidence may include, but is not limited to, a measured event confidence (to be specific, a measured confidence of the road traffic event).

The measured position confidence indicates a position accuracy with a 95% confidence level. For example, the measured position confidence may be 1 meter, 2 meters, or the like. A unit used for the measured position confidence is not limited herein. The measured speed confidence indicates a speed accuracy with a 95% confidence level. For example, the measured speed confidence may be 0.1 m/s, 1 m/s, or the like. A unit used for the measured speed confidence is not limited herein. The measured heading angle confidence indicates a heading accuracy with a 95% confidence level. For example, the measured heading angle confidence may be 0.1 degrees, 1 degree, or the like. The measured size confidence indicates a size accuracy with a 95% confidence level. For example, the measured size confidence may be 1 meter, 2 meters, or the like. A unit used for the measured size confidence is not limited herein. The measured type confidence indicates a value of a confidence level. For example, the measured type confidence may be 90%, 95%, or the like. The measured event confidence indicates a value of a confidence level. For example, the measured event confidence may be 90%, 95%, or the like.

For the measured position confidence, the measured speed confidence, the measured heading angle confidence, and the measured size confidence, the 95% confidence level may represent a reliability degree of the test sensing data predicted by the road side sensing device (for example, the 95% confidence level corresponding to the measured position confidence indicates that a reliability degree of a test position predicted by the road side sensing device is 95%), where the value of 95% is an industry standard, and actually, a specific value of the confidence level is not limited to 95%.

The baseline in the baseline performance information means a basic indicator threshold for each indicator (for example, the position indicator, the speed indicator, the heading angle indicator, the size indicator, the type indicator, or the event indicator described above) in the test scenario. The baseline performance information stores information indicating whether a test result of the road side sensing device can meet the basic indicator threshold, and does not need to store a real test result. In other words, the baseline performance information stores a test certification level of the road side sensing device in the test certification scenario. The test certification level may indicate a basic indicator threshold for each indicator corresponding to the road side sensing device.

In addition, for each indicator, thresholds corresponding to a plurality of measured confidences (in other words, a plurality of basic indicator thresholds) may be defined herein, and different levels corresponding to the road side sensing device may be determined based on the thresholds corresponding to the plurality of measured confidences. For example, the speed indicator may correspond to a plurality of basic indicator thresholds, and the plurality of basic indicator thresholds for the speed indicator may include, but are not limited to, A1, A2, A3, and the like. Performance of the road side sensing device (namely, the road side sensing system) may be divided into several levels based on a combination of the plurality of thresholds of different indicators. When all indicators of the road side sensing device meet basic indicator thresholds in a same level, a test certification level of the road side sensing device in a specific test certification scenario can be determined.

Level 1 indicates that the measured position confidence is less than A1 meters, the measured speed confidence is less than B1 m/s, the measured heading angle confidence is less than C1 degrees, the measured size confidence is less than D1 meters, the measured type confidence is greater than E1%, and the measured confidence of road traffic event is greater than F1%. Level 2 indicates that the measured position confidence is less than A2 meters, the measured speed confidence is less than B2 m/s, the measured heading angle confidence is less than C2 degrees, the measured size confidence is less than D2 meters, the measured type confidence is greater than E2%, and the measured confidence of road traffic event is greater than F2%. Level 3 indicates that the measured position confidence is less than A3 meters, the measured speed confidence is less than B3 m/s, the measured heading angle confidence is less than C3 degrees, the measured size confidence is less than D3 meters, the measured type confidence is greater than E3%, and the measured confidence of road traffic event is greater than F3%.

A number of levels obtained through division is not limited herein, and all levels and respective basic indicator thresholds corresponding to the levels are not enumerated herein. When level 1 is higher than level 2, a value of A1 is less than a value of A2, and when level 2 is higher than level 3, the value of A2 is less than a value of A3, indicating that a position error is smaller at a higher level. When level 1 is higher than level 2, a value of E1 is greater than a value of E2, and when level 2 is higher than level 3, the value of E2 is greater than a value of E3, indicating that the measured type confidence is greater at a higher level. Similarly, for values of other indicators, refer to the foregoing descriptions of A1, A2, A3, E1, E2, and E3. For B1, B2, B3, C1, C2, C3, D1, D2, and D3, refer to the descriptions of A1, A2, and A3; and for F1, F2, and F3, refer to the descriptions of E1, E2, and E3, and details are not described again herein.

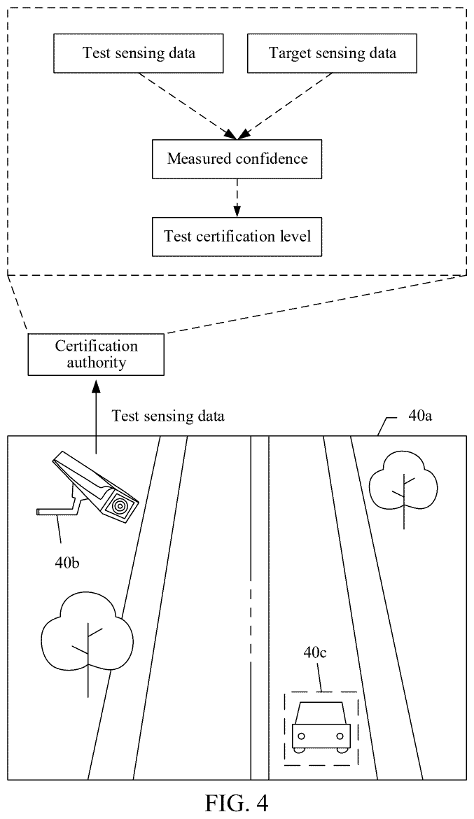

FIG. 4 is a schematic diagram of a scenario of generating baseline performance information according to some embodiments. As shown in FIG. 4, the certification authority may provide a test scenario 40a, and the test scenario 40a may include one or more test objects. For ease of understanding, an example in which the test scenario 40a includes one test object is used for description herein. The test object in the test scenario 40a may be a test object 40c, and the test object 40c herein may be a traffic participant.

As shown in FIG. 4, a road side sensing device 40b may perform sensing in the test scenario 40a, generate test sensing data of the test object 40c, and then send the test sensing data to the certification authority. The test sensing data of the test object 40c generated by the road side sensing device 40b may include, but is not limited to, a test position, a test speed, a test heading angle, a test size, and a test type.

Because the test scenario 40a is provided by the certification authority, the certification authority may directly obtain target sensing data of the test object 40c, and the target sensing data of the test object 40c may include, but is not limited to, a target position, a target speed, a target heading angle, a target size, and a target type. As shown in FIG. 4, the certification authority may generate a measured confidence of the test object 40c based on the target sensing data and the test sensing data.

The certification authority may generate a measured position confidence of the test object 40c based on the test position and the target position; the certification authority may generate a measured speed confidence of the test object 40c based on the test speed and the target speed; the certification authority may generate a measured heading angle confidence of the test object 40c based on the test heading angle and the target heading angle; the certification authority may generate a measured size confidence of the test object 40c based on the test size and the target size; and the certification authority may generate a measured type confidence of the test object 40c based on the test type and the target type.

Further, as shown in FIG. 4, the certification authority may determine a test certification level of the road side sensing device 40b in the test scenario 40a based on the measured position confidence, the measured speed confidence, the measured heading angle confidence, the measured size confidence, and the measured type confidence. The measured position confidence, the measured speed confidence, the measured heading angle confidence, the measured size confidence, and the measured type confidence may be collectively referred to as a measured confidence of the test object 40c.

S102: Obtain road side sensing data generated by the road side sensing device, and transmit the road side sensing data and the baseline performance information to an on board terminal, so that the on board terminal adjusts the road side sensing data based on the baseline performance information.

The on board terminal may adjust the road side sensing data based on the baseline performance information, and the on board terminal is located in the road side area.

The road side communication device may send the road side sensing data and the baseline performance information to the on board terminal simultaneously, or may send the road side sensing data and the baseline performance information to the on board terminal separately. Information interaction manners between the road side communication device and the on board terminal include, but are not limited to, a broadcast manner (there is no specific receiving object, and all traffic participants within communication reach can receive a corresponding message), a multicast mode (there are specific receiving objects, and a specific group of traffic participants within communication reach can receive a corresponding message), a unicast manner (there is a specific receiving object, and only one specific traffic participant within communication reach can receive a corresponding message), and the like, and this is not limited herein.

The road side communication device may receive a road side performance message sent by the road side sensing device, and receive a road side traffic message sent by the road side sensing device. The road side performance message carries the baseline performance information of the road side sensing device, and the road side traffic message carries the road side sensing data generated by the road side sensing device. Further, the road side communication device may send the road side traffic message and the road side performance message to the on board terminal.

The road side performance message includes a test pass field indicating the test pass information, a test certificate field indicating the test certificate information, a certification scenario field indicating the test certification scenario, and a certification level field indicating the test certification level.

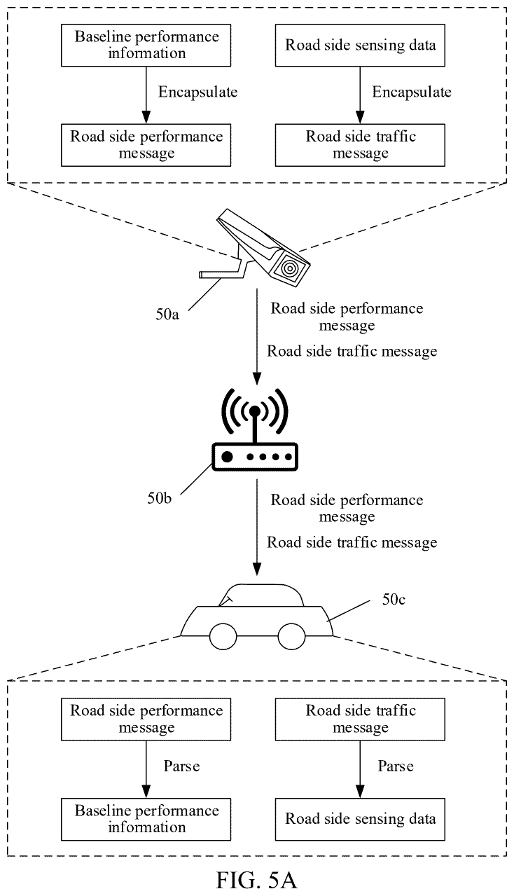

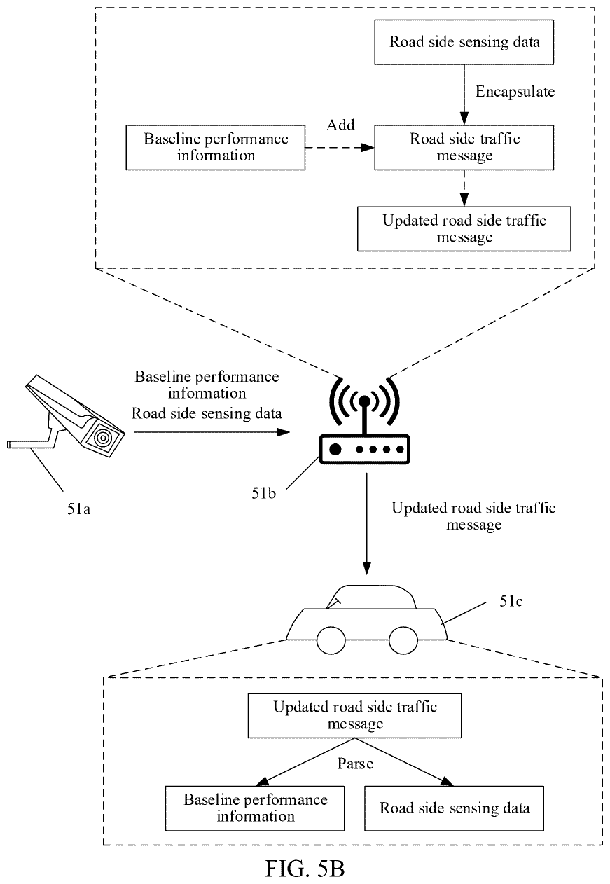

For a specific process in which the road side sensing device sends the road side performance message and the road side traffic message to the on board terminal, refer to FIG. 5A. FIG. 5A is a schematic diagram of a scenario of message interaction according to some embodiments. As shown in FIG. 5A, a road side sensing device 50a may encapsulate the baseline performance information to obtain the road side performance message; and the road side sensing device 50a may encapsulate the road side sensing data to obtain the road side traffic message. The road side traffic message may include, but is not limited to, a road safety message, road side information, and a signal status message.

Further, as shown in FIG. 5A, the road side sensing device 50a may send the road side performance message and the road side traffic message to a road side communication device 50b. In this way, the road side communication device 50b can forward the road side performance message and the road side traffic message to an on board terminal 50c.

In some embodiments, the road side communication device may receive the baseline performance information sent by the road side sensing device, and receive the road side sensing data sent by the road side sensing device. Further, the road side communication device may generate a road side traffic message that carries the road side sensing data; add the baseline performance information to the road side traffic message, to obtain an updated road side traffic message; and transmit the updated road side traffic message to the on board terminal. In other words, the road side communication device may generate the updated road side traffic message that carries the road side sensing data and the baseline performance information.

The updated road side traffic message includes a test pass field indicating the test pass information, a test certificate field indicating the test certificate information, a certification scenario field indicating the test certification scenario, and a certification level field indicating the test certification level.

FIG. 5B is a schematic diagram of a scenario of message interaction according to some embodiments. As shown in FIG. 5B, a road side sensing device 51a may send the baseline performance information and the road side sensing data to a road side communication device 51b.

Further, as shown in FIG. 5B, the road side communication device 51b may encapsulate the road side sensing data to obtain the road side traffic message, and then add the baseline performance information to the road side traffic message to obtain an updated road side traffic message. The road side traffic message may include, but is not limited to, a road safety message, road side information, and a signal status message. In other words, the road side communication device 51b may encapsulate the road side sensing data and the baseline performance information, to obtain the updated road side traffic message. In this way, the road side communication device 51b can forward the update road side traffic message to an on board terminal 51c.

A confidence (namely, a measured confidence) of the baseline performance information is a confidence that is actually tested in the test scenario, and the road side sensing data may also include a confidence (namely, a sensing confidence), while the confidence in the road side sensing data is a confidence set by an algorithm in actual system operation (the confidence is closely related to an actual deployment scenario and operating condition of the system).

Some embodiments support the on board terminal to receive the baseline performance information being configured for representing the sensing capability of the road side sensing device while receiving the road side sensing data generated by the road side sensing device. Because sensing capabilities of different road side sensing devices are different, and accuracies of road side sensing data generated by road side sensing devices of different sensing capabilities are different, based on the different sensing capabilities indicated by the baseline performance information, the road side sensing data can be adjusted to different degrees, to ensure an accuracy of the adjusted road side sensing data, and when the adjusted road side sensing data is processed, an accuracy of a processing result of the adjusted road side sensing data is improved, in other words, an accuracy of a processing result obtained based on the road side sensing data is improved.

FIG. 6 is a schematic flowchart of a data processing method according to some embodiments. The method may be performed by a road side communication device, may be performed by an on board terminal, or may be jointly performed by a road side communication device and an on board terminal. The road side communication device may be the foregoing road side communication device 20a in the embodiment corresponding to FIG. 2, and the on board terminal may be the foregoing on board terminal 20b in the embodiment corresponding to FIG. 2. In some embodiments, the method is performed by an on board terminal. The data processing method may include the following operations:

S201: Receive road side sensing data and baseline performance information sent by a road side communication device.

The road side sensing data is generated by a road side sensing device, the road side sensing device is located in a road side area covered by the road side communication device, the baseline performance information is configured for representing a sensing capability of the road side sensing device, the on board terminal is located in the road side area, and the on board terminal may adjust the road side sensing data based on the baseline performance information.

The on board terminal may receive the road side traffic message and the road side performance message sent by the road side communication device. Further, the on board terminal may parse the road side traffic message to obtain the road side sensing data; and the on board terminal may parse the road side performance message to obtain the baseline performance information.

Referring to FIG. 5A again, after receiving the road side performance message and the road side traffic message, the on board terminal 50c may parse the road side performance message to obtain the baseline performance information, and parse the road side traffic message to obtain the road side sensing data. In other words, the on board terminal 50c may obtain the baseline performance information from the road side performance message, and obtain the road side sensing data from the road side traffic message.

In some embodiments, the on board terminal may receive an updated road side traffic message sent by the road side communication device. Further, the on board terminal may parse the update road side traffic message, to obtain the road side sensing data and the baseline performance information.

Referring to FIG. 5B again, after receiving the updated road side traffic message, the on board terminal 51c may parse the updated road side traffic message to obtain the baseline performance information and the road side sensing data. In other words, the on board terminal 51c may obtain the baseline performance information and the road side sensing data from the updated road side traffic message.

The baseline performance information is generated by the road side sensing device based on a test scenario provided by a certification authority, and the baseline performance information may include at least one of test pass information, test certificate information, a test certification scenario, or a test certification level. In one embodiment, the baseline performance information includes the test pass information, the test certificate information, the test certification scenario, and the test certification level. For ease of understanding, embodiments are described by using an example in which the baseline performance information includes the test pass information, the test certificate information, the test certification scenario, and the test certification level. The test pass information is configured for representing a test passing status of the road side sensing device; the test certificate information is configured for representing a certificate number provided by the certification authority for the road side sensing device; the test certification scenario is configured for representing the test scenario; and the test certification level is configured for representing the sensing capability of the road side sensing device in the test scenario.

S202: Perform information verification on the baseline performance information, and adjust the road side sensing data based on a verification result.

In some embodiments, the operation further includes: determining, based on the baseline performance information, whether to perform first adjustment processing on the road side sensing data; and if determining to perform the first adjustment processing on the road side sensing data, fusing vehicle side sensing data and adjusted road side sensing data, to obtain fused sensing data, where the fused sensing data is configured for performing a driving policy.

If the test pass information and the test certificate information indicate that the road side sensing device fails a test of the certification authority, the on board terminal may downgrade the road side sensing data. In some embodiments, if the test pass information and the test certificate information indicate that the road side sensing device passes the test of the certification authority (to be specific, the test pass information indicates that the test is passed, and the test certificate information has a certificate number), the on board terminal may adjust the road side sensing data based on the test certification scenario and the test certification level. The test pass information and the test certificate information each may indicate whether the road side sensing device passes the test of the certification authority. In some embodiments, when the baseline performance information includes the test pass information and the test certificate information, if the test pass information and the test certificate information indicate that the road side sensing device passes the test of the certification authority, the on board terminal does not need to adjust the road side sensing data (in other words, the verification result indicates that the verification is passed).

The road side sensing data includes a sensing confidence of a sensing object, and the sensing confidence includes at least one of an error confidence or a probability confidence. Sensing objects may include, but are not limited to, a traffic participant, a traffic obstruction, and a traffic event. If the sensing object includes a traffic participant, road side sensing data of the traffic participant may include, but is not limited to, a sensing position, a sensing speed, a sensing heading angle, a sensing size, and a sensing type. Therefore, the sensing confidence may include, but is not limited to, a position confidence, a speed confidence, a heading angle confidence, a size confidence, and a type confidence. If the sensing object includes a traffic obstruction, road side sensing data of the traffic obstruction may include, but is not limited to, a sensing position, a sensing speed, a sensing heading angle, a sensing size, and a sensing type. Therefore, the sensing confidence may include, but is not limited to, a position confidence, a speed confidence, a heading angle confidence, a size confidence, and a type confidence. If the sensing object includes a traffic event, road side sensing data of the traffic event may include, but is not limited to, a sensing event. Therefore, the sensing confidence may include, but is not limited to, an event confidence (to be specific, a confidence of the road traffic event).

The position confidence indicates a position accuracy with a 95% confidence level. For example, the position confidence may be 1 meter, 2 meters, or the like. A unit used for the position confidence is not limited herein. The speed confidence indicates a speed accuracy with a 95% confidence level. For example, the speed confidence may be 0.1 m/s, 1 m/s, or the like. A unit used for the speed confidence is not limited herein. The heading angle confidence indicates a heading accuracy with a 95% confidence level. For example, the heading angle confidence may be 0.1 degrees or 1 degree. The size confidence indicates a size accuracy with a 95% confidence level. For example, the size confidence may be 1 meter or 2 meters. A unit used for the size confidence is not limited herein. The type confidence indicates a value of a confidence level. For example, the type confidence may be 90%, 95%, or the like. The event confidence indicates a value of a confidence level. For example, the event confidence may be 90%, 95%, or the like.

For the position confidence, the speed confidence, the heading angle confidence, and the size confidence, the 95% confidence level may represent a reliability degree of the road side sensing data predicted by the road side sensing device (for example, the 95% confidence level corresponding to the position confidence indicates that a reliability degree of a sensing position predicted by the road side sensing device is 95%), where the value of 95% is an industry standard, and actually, a specific value of the confidence level is not limited to 95%.

A process in which the on board terminal downgrade the road side sensing data may be described as follows: if the road side sensing data includes the error confidence, increasing an error value indicated by the error confidence (that is, increasing the error confidence); or if the road side sensing data includes the probability confidence, reducing a probability value indicated by the probability confidence (that is, reducing the probability confidence). The error confidence may include the position confidence, the speed confidence, the heading angle confidence, and the magnitude confidence, and the probability confidence may include the type confidence and the event confidence. In other words, for accuracy indicators (namely, the error confidence) that are uniformly expressed at the 95% confidence level, the accuracy may be reduced, for example, 1 meter is increased to 2 meters; and for indicators (namely, the probabilistic confidence) directly expressed in the confidence level, the confidence level may be reduced, for example, 95% is reduced to 85%.

If the sensing object includes a traffic participant, the on board terminal may increase a position confidence of the traffic participant, a speed confidence of the traffic participant, a heading angle confidence of the traffic participant, and a size confidence of the traffic participant, and reduce a type confidence of the traffic participant. Similarly, if the sensing object includes a traffic obstruction, the on board terminal may increase a position confidence of the traffic obstruction, a speed confidence of the traffic obstruction, a heading angle confidence of the traffic obstruction, and a size confidence of the traffic obstruction, and reduce a type confidence of the traffic obstruction. Similarly, if the sensing object includes a traffic event, the on board terminal may reduce an event confidence of the traffic event.

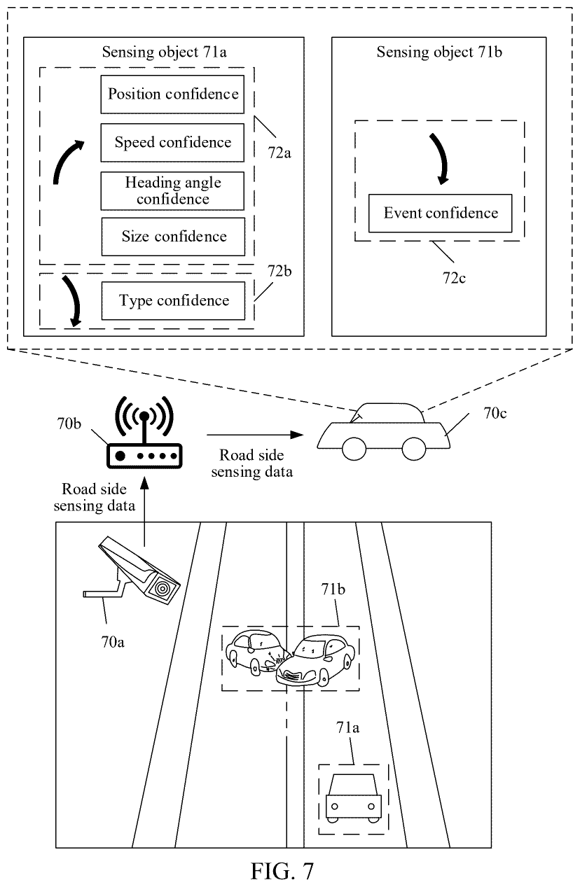

FIG. 7 is a schematic diagram of a scenario of downgrading according to some embodiments. As shown in FIG. 7, a road side sensing device 70a may sense sensing objects on a road, where the sensing objects herein may include a traffic participant 71a and a traffic event 71b. Therefore, the road side sensing device 70a may generate road side sensing data based on the traffic participant 71a (namely, a sensing object 71a) and the traffic event 71b (namely, a sensing object 71b), send the road side sensing data to a road side communication device, where the road side communication device herein may be a road side communication device 70b.

As shown in FIG. 7, after receiving the road side sensing data, the road side communication device 70b may send the road side sensing data to an on board terminal, where the on board terminal herein may be an on board terminal 70c. In this way, the on board terminal 70c can obtain a position confidence of the traffic participant 71a, a speed confidence of the traffic participant 71a, a heading angle confidence of the traffic participant 71a, a size confidence of the traffic participant 71a, and a type confidence of the traffic participant 71a from the road side sensing data, and obtain an event confidence of the traffic event 71b from the road side sensing data. The position confidence of the traffic participant 71a, the speed confidence of the traffic participant 71a, the heading angle confidence of the traffic participant 71a, and the size confidence of the traffic participant 71a may be collectively referred to as an error confidence 72a, the type confidence of the traffic participant 71a may be collectively referred to as a probability confidence 72b, and the event confidence of the traffic event 71b may be collectively referred to as a probability confidence 72c.

As shown in FIG. 7, after receiving the road side sensing data, the on board terminal 70c may downgrade the road side sensing data, to be specific, increase the error confidence 72a, and reduce the probability confidence 72b and the probability confidence 72c. Further, the on board terminal 70c may use the downgraded road side sensing data as adjusted road side sensing data, and then perform subsequent operations based on the adjusted road side sensing data.

A process in which the on board terminal adjusts the road side sensing data based on the test certification scenario and the test certification level may be described as follows: The on board terminal may identify a driving scenario of the on board terminal; and if the test certification scenario does not include the driving scenario, the on board terminal downgrades the road side sensing data. In some embodiments, if the test certification scenario includes the driving scenario, the on board terminal performs confidence filtering on the road side sensing data based on the test certification level. In some embodiments, when the baseline performance information includes the test pass information, the test certificate information, and the test certification scenario, if the test certification scenario includes the driving scenario, the on board terminal does not need to adjust the road side sensing data (in other words, the verification result indicates that the verification is passed).

The road side sensing data includes sensing object data and a sensing confidence of a sensing object, and the sensing object includes at least one of a traffic participant, a traffic obstruction, or a traffic event. Sensing object data of the traffic participant may include, but is not limited to, a sensing position, a sensing speed, a sensing heading angle, a sensing size, and a sensing type. Sensing object data of the traffic obstruction may include, but is not limited to, a sensing position, a sensing speed, a sensing heading angle, a sensing size, and a sensing type. Sensing object data of the traffic event may include, but is not limited to, a sensing event.

A process in which the on board terminal performs confidence filtering on the road side sensing data based on the test certification level may be described as follows: The on board terminal may obtain an autonomous driving level corresponding to the on board terminal; and if the test certification level does not meet an autonomous driving condition indicated by the autonomous driving level (in other words, a certification level of the road side sensing system meets or is higher than a requirement of the vehicle), the on board terminal compares the sensing confidence of the sensing object with a confidence condition. Further, if the sensing confidence of the sensing object does not meet the confidence condition, the on board terminal may delete the sensing object data and the sensing confidence of the sensing object from the road side sensing data.

In some embodiments, if the sensing confidence of the sensing object meets the confidence condition, the on board terminal does not need to adjust the road side sensing data (in other words, the verification result indicates that the verification is passed). In some embodiments, if the test certification level meets the autonomous driving condition indicated by the autonomous driving level (in other words, the certification level of the road side sensing system does not meet the requirement of the vehicle), the on board terminal does not need to adjust the road side sensing data (in other words, the verification result indicates that the verification is passed). For example, assuming that the baseline performance information received by the on board terminal satisfies autonomous driving systems of L0 to L3 (representing low-level autonomous driving), if the on board terminal is an L4 autonomous driving system (to be specific, highly automated driving, representing high-level autonomous driving), and has a high performance requirement on the road side sensing data, the on board terminal may determine that the certification level of the road side sensing system does not meet the requirement of the vehicle, in other words, the test certification level does not meet the autonomous driving condition indicated by the autonomous driving level. In other words, if a driving level indicated by the test certification level is L0 to L3 (or L3), and an autonomous driving level is L4, the on board terminal may determine that the driving level of L3 is lower than the driving level of L4, thereby determining that the test certification level does not meet the autonomous driving condition indicated by the autonomous driving level.

If a sensing confidence of a specific sensing object does not meet a confidence threshold requirement, sensing data of the sensing object may be removed, where different sensing confidences may correspond to different confidence thresholds. A confidence threshold corresponding to the position confidence may be referred to as a position confidence threshold, a confidence threshold corresponding to the speed confidence may be referred to as a speed confidence threshold, a confidence threshold corresponding to the heading angle confidence may be referred to as a heading angle confidence threshold, a confidence threshold corresponding to the size confidence may be referred to as a size confidence threshold, a confidence threshold corresponding to the type confidence may be referred to as a type confidence threshold, and a confidence threshold corresponding to the event confidence may be referred to as an event confidence threshold. Specific values of the position confidence threshold, the speed confidence threshold, the heading angle confidence threshold, the size confidence threshold, and the type confidence threshold are not limited herein.

The confidence condition is a condition that the position confidence is less than the position confidence threshold, the speed confidence is less than the speed confidence threshold, the heading angle confidence is less than the heading angle confidence threshold, the size confidence is less than the size confidence threshold, the type confidence is greater than the type confidence threshold, the event confidence is greater than the event confidence threshold. The autonomous driving condition is a condition in which the test certification level matches the autonomous driving level. In other words, the autonomous driving condition is a condition in which a driving level indicated by the test certification level is lower than or equal to the autonomous driving level.

If all sensing confidences of a specific sensing object meet the confidence threshold requirements, it may be determined that the sensing confidence of the sensing object meets the confidence condition. For a traffic participant, if a position confidence of the traffic participant is less than the position confidence threshold, a speed confidence of the traffic participant is less than the speed confidence threshold, a heading angle confidence of the traffic participant is less than the heading angle confidence threshold, a size confidence of the traffic participant is less than the size confidence threshold, and a type confidence of the traffic participant is greater than the type confidence threshold, it is determined that a sensing confidence of the traffic participant meets the confidence condition. Similarly, for a traffic participant, if a position confidence of the traffic participant is not less than the position confidence threshold, a speed confidence of the traffic participant is not less than the speed confidence threshold, a heading angle confidence of the traffic participant is not less than the heading angle confidence threshold, a size confidence of the traffic participant is not less than the size confidence threshold, or a type confidence of the traffic participant is not greater than the type confidence threshold, it is determined that a sensing confidence of the traffic participant does not meet the confidence condition. In other words, if one, two, three, four, or five of the five indicators of the traffic participant do not meet the threshold requirements, sensing data of the traffic participant may be removed.

For a traffic obstruction, if a position confidence of the traffic obstruction is less than the position confidence threshold, a speed confidence of the traffic obstruction is less than the speed confidence threshold, a heading angle confidence of the traffic obstruction is less than the heading angle confidence threshold, a size confidence of the traffic obstruction is less than the size confidence threshold, and a type confidence of the traffic obstruction is greater than the type confidence threshold, it is determined that a sensing confidence of the traffic obstruction meets the confidence condition. Similarly, for a traffic obstruction, if a position confidence of the traffic obstruction is not less than the position confidence threshold, a speed confidence of the traffic obstruction is not less than the speed confidence threshold, a heading angle confidence of the traffic obstruction is not less than the heading angle confidence threshold, a size confidence of the traffic obstruction is not less than the size confidence threshold, and a type confidence of the traffic obstruction is not greater than the type confidence threshold, it is determined that a sensing confidence of the traffic obstruction does not meet the confidence condition. In other words, if one, two, three, four, or five of the five indicators of the traffic obstruction do not meet the threshold requirements, sensing data of the traffic obstruction may be removed.

For a traffic event, if an event confidence of the traffic event is greater than the event confidence threshold, it is determined that a sensing confidence of the traffic event meets the confidence condition. Similarly, for a traffic event, if an event confidence of the traffic event is not greater than the event confidence threshold, it is determined that a sensing confidence of the traffic event does not meet the confidence condition.

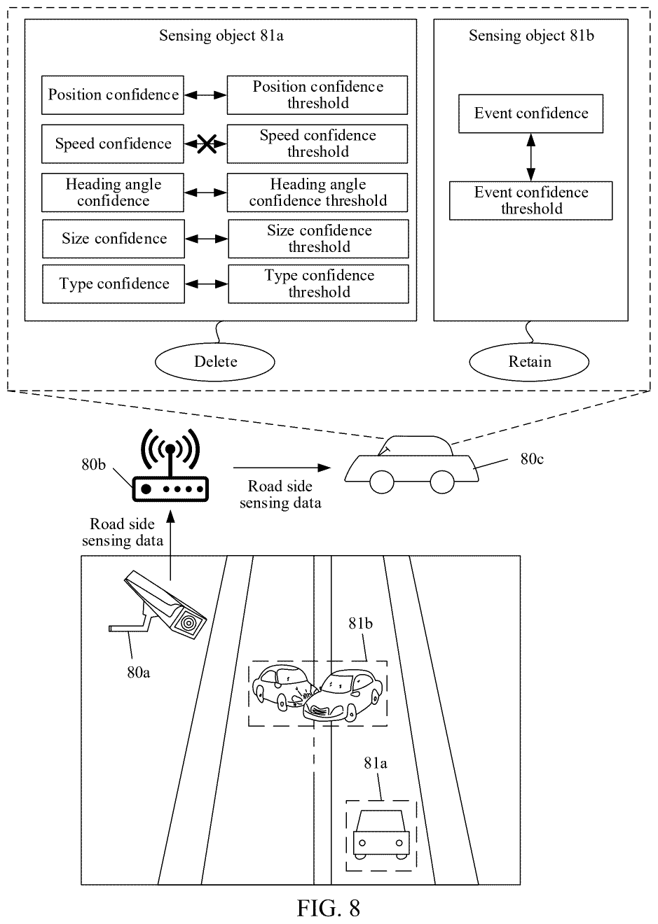

FIG. 8 is a schematic diagram of a scenario of confidence filtering according to some embodiments. As shown in FIG. 8, a road side sensing device 80a may be the foregoing road side sensing device 70a in the embodiment corresponding to FIG. 7, a road side communication device 80b may be the foregoing road side communication device 70b in the embodiment corresponding to FIG. 7, an on board terminal 80c may be the foregoing on board terminal 70c in the embodiment corresponding to FIG. 7, a traffic participant 81a (namely, a sensing object 81a) may be the foregoing traffic participant 71a in the embodiment corresponding to FIG. 7, and a traffic event 81b (namely, a sensing object 81b) may be the foregoing traffic event 71b in the embodiment corresponding to FIG. 7.

As shown in FIG. 8, after receiving the road side sensing data, the on board terminal 80c may compare a position confidence of the traffic participant 81a with a position confidence threshold, compare a speed confidence of the traffic participant 81a with a speed confidence threshold, compare a heading angle confidence of the traffic participant 81a with a heading angle confidence threshold, compare a size confidence of the traffic participant 81a with a size confidence threshold, compare a type confidence of the traffic participant 81a with a type confidence threshold. Similarly, the on board terminal 80c may compare an event confidence of the traffic event 81b with an event confidence threshold.

Further, it is assumed herein that the position confidence of the traffic participant 81a is less than the position confidence threshold, the speed confidence of the traffic participant 81a is not less than (in other words, greater than or equal to) the speed confidence threshold, the heading angle confidence of the traffic participant 81a is less than the heading angle confidence threshold, the size confidence of the traffic participant 81a is less than the size confidence threshold, and the type confidence of the traffic participant 81a is greater than the type confidence threshold. Therefore, the on board terminal 80c may determine that a sensing confidence of the traffic participant does not meet a confidence condition. It is assumed herein that the event confidence of the traffic event 81b is greater than the event confidence threshold. Therefore, the on board terminal 80c may determine that the sensing confidence of the traffic event 81b meets the confidence condition.

As shown in FIG. 8, the on board terminal 80c may perform confidence filtering on the road side sensing data, to be specific, delete the sensing data of the traffic participant 81a (the sensing data of the traffic participant 81a may include sensing object data and sensing confidence of the traffic participant 81a), retain the sensing data of the traffic event 81b (the sensing data of the traffic event 81b includes sensing object data and sensing confidence of the traffic event 81b). Further, the on board terminal 80c uses the confidence-filtered road side sensing data as adjusted road side sensing data, and then perform subsequent operations based on the adjusted road side sensing data.

If the road side sensing data is downgraded, or sensing object data and a sensing confidence of a specific sensing object are deleted from the road side sensing data, the on board terminal may determine that a verification result of the baseline performance information indicates that the verification is not passed; or if there is no need to adjust the road side sensing data, the on board terminal may determine that a verification result of the baseline performance information indicates that the verification is passed.

Manners of performing information verification on the foregoing test pass information, test certificate information, test certification scenario, or test certification level include but are not limited to the combination manner described above, and manners of processing the road side sensing data include but are not limited to the foregoing manners of downgrading and confidence filtering. For example, if the baseline performance information includes the test certification scenario, the on board terminal may identify a driving scenario of the on board terminal (in this case, because the baseline performance information does not include the test pass information, the test certificate information, and the test certification level, the on board terminal does not need to determine whether the road side sensing device passes a test of the certification authority and does not need to obtain an autonomous driving level corresponding to the on board terminal). Further, if the test certification scenario does not include the driving scenario, the on board terminal downgrades the road side sensing data. For another example, if the baseline performance information includes the test certification level, the on board terminal may obtain an autonomous driving level corresponding to the on board terminal (in this case, because the baseline performance information does not include the test pass information, the test certificate information, and the test certification scenario, the on board terminal does not need to determine whether the road side sensing device passes a test of the certification authority and does not need to identify a driving scenario of the on board terminal). Further, if the test certification level does not meet an autonomous driving condition indicated by the autonomous driving level, the on board terminal performs confidence filtering on the road side sensing data (to be specific, compares the sensing confidence of the sensing object with the confidence condition). For another example, if the baseline performance information includes the test certification scenario, the on board terminal may identify a driving scenario of the on board terminal (in this case, because the baseline performance information does not include the test pass information, the test certificate information, and the test certification level, the on board terminal does not need to determine whether the road side sensing device passes a test of the certification authority and does not need to obtain an autonomous driving level corresponding to the on board terminal). Further, if the test certification scenario does not include the driving scenario, the on board terminal performs confidence filtering on the road side sensing data. For another example, if the baseline performance information includes the test certification scenario and the test certification level, the on board terminal may identify a driving scenario of the on board terminal (in this case, because the baseline performance information does not include the test pass information and the test certificate information, the on board terminal does not need to determine whether the road side sensing device passes a test of the certification authority). Further, if the test certification scenario does not include the driving scenario, the on board terminal determines whether the test certification level meets an autonomous driving condition indicated by an autonomous driving level corresponding to the on board terminal.

Some embodiments support the on board terminal to receive the baseline performance information being configured for representing the sensing capability of the road side sensing device while receiving the road side sensing data generated by the road side sensing device. Because sensing capabilities of different road side sensing devices are different, and accuracies of road side sensing data generated by road side sensing devices of different sensing capabilities are different, based on the different sensing capabilities indicated by the baseline performance information, the road side sensing data can be adjusted to different degrees, to ensure an accuracy of the adjusted road side sensing data, and when the adjusted road side sensing data is processed, an accuracy of a processing result of the adjusted road side sensing data is improved, in other words, an accuracy of a processing result obtained based on the road side sensing data is improved.

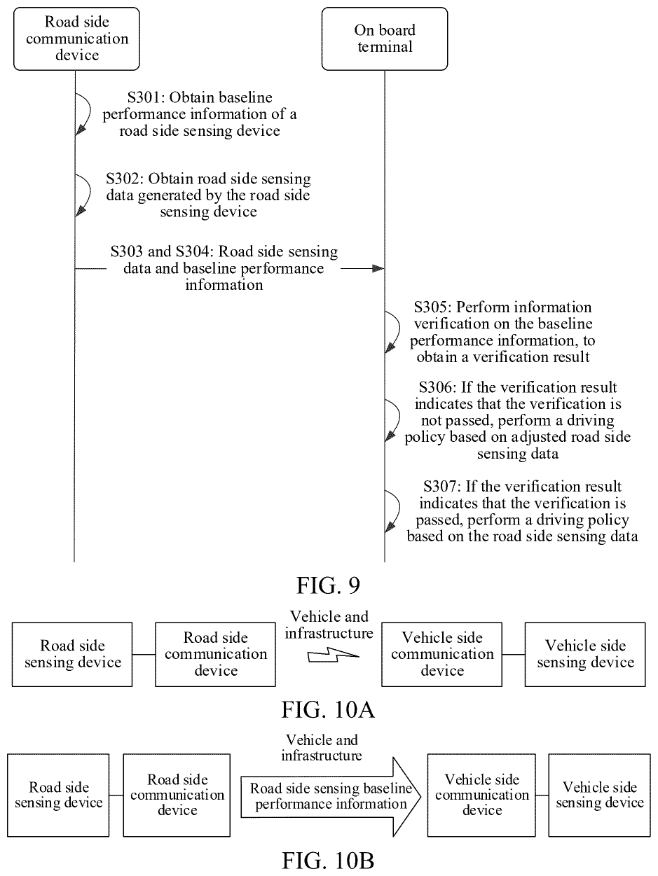

FIG. 9 is a schematic flowchart of a data processing method according to some embodiments. The method may be performed by a road side communication device, may be performed by an on board terminal, or may be jointly performed by a road side communication device and an on board terminal. The road side communication device may be the foregoing road side communication device 20a in the embodiment corresponding to FIG. 2, and the on board terminal may be the foregoing on board terminal 20b in the embodiment corresponding to FIG. 2. Some embodiments provide a method that is jointly performed by a road side communication device and an on board terminal. The data processing method may include the following operations:

S301: The road side communication device obtains baseline performance information of a road side sensing device.

For a process in which the road side communication device obtains the baseline performance information, refer to the descriptions of operation S101 in the foregoing embodiment corresponding to FIG. 3, and this is not described herein again.

S302: The road side communication device obtains road side sensing data generated by the road side sensing device.

For a specific process in which the road side communication device obtains the road side sensing data, refer to the descriptions of operation S102 in the foregoing embodiment corresponding to FIG. 3, and this is not described herein again.

S303: The road side communication device sends the road side sensing data and the baseline performance information to the on board terminal.

The road side communication device may send the baseline performance information via a road side performance message, and send the road side sensing data via a road side traffic message. The road side traffic message is a road safety message including the road side sensing data; or the road side traffic message is road side information including the road side sensing data; or the road side traffic message is road side status information including the road side sensing data. In other words, the road side traffic message may include, but is not limited to, a road safety message, road side information, and road side status information.

In some embodiments, the road side communication device may send the baseline performance information and the road side sensing data via an updated road side traffic message. The updated road side traffic message is a road safety message including the baseline performance information; or the updated road side traffic message is road side information including the baseline performance information; or the updated road side traffic message is road side status information including the baseline performance information. In other words, the updated road side traffic message is a road safety message including the baseline performance information and the road side sensing data; or the updated road side traffic message is road side information including the baseline performance information and the road side sensing data; or the updated road side traffic message is road side status information including the baseline performance information and the road side sensing data. In other words, the updated road side traffic message may include, but is not limited to, a road safety message, road side information, and road side status information.

Table 2 shows a format of a road safety message according to some embodiments. The RSM message in Table 2 may store sensing object data and a sensing confidence of a traffic participant. As shown in Table 2:

TABLE 2

| Field name | Descriptions |
|---|---|
| pos | Relative position of three-dimensional coordinates |
| | of the traffic participant |
| posConfidence | Position confidence of the traffic participant, |
| | including a longitude, a latitude, an elevation, and |
| | the like |
| speed | Speed of the traffic participant |
| heading | Clockwise included angle between a motion |
| | direction of the traffic participant and true north |
| motionCfd | Confidence of a vehicle motion status, including |
| | confidences of vehicle speed and heading angle |
| size | Size of the traffic participant |
| . . . | . . . |

The pos field (sensing position), the speed field (sensing speed), the heading field (sensing heading angle), and the size field (sensing size) may represent the sensing object data of the traffic participant, and the posConfidence field (position confidence) and the motionCfd field (status confidence) may represent the sensing confidence of the traffic participant. The fields in Table 2 are not enumerated herein. For example, Table 2 may further include a ptcType field (type of the traffic participant identified on a road side), a ptcld field (temporary number of the traffic participant on the road side), a source field (source of traffic participant data), an ID field (temporary vehicle or terminal ID obtained from a BSM message), a secMark field (timestamp, millisecond-level moments within one minute), a transmission field (vehicle gear status), an angle field (vehicle steering wheel angle), an accelSet field (vehicle four axis acceleration), a vehicleClass field (vehicle type), and the like.

Table 3 shows a format of a signal status message according to some embodiments. The sensing object data and the sensing confidence of the traffic participant may be stored in the SSM message in Table 3. The SSM message is an extension based on the RSM message, and further includes a size confidence and a type confidence in addition to the position confidence and the status confidence of the traffic participant in Table 2. As shown in Table 3:

TABLE 3

| Field name | Descriptions |
|---|---|
| objSizeConfidence | Size confidence |
| detectedPTCType | Type of the traffic participant identified on a road |
| | side, where the type is added compared with the |
| | fields in Table 2 |
| typeConfidence | Type confidence of the traffic participant |
| . . . | . . . |

The detectedPTCType field (sensing type) may represent the sensing object data of the traffic participant, and the objSizeConfidence field (size confidence) and the typeConfidence field (type confidence) may represent the sensing confidence of the traffic participant. The fields in Table 3 are not enumerated herein.

Table. 4 shows a format of a signal status message according to some embodiments. Sensing object data and sensing confidence of a traffic obstruction may be stored in the SSM message in Table 4. As shown in Table 4:

TABLE 4

| Field name | Descriptions |
|---|---|
| obsType | Type of a traffic obstruction identified on a road |
| | side |
| objTypeConfidence | Type confidence of the traffic obstruction |
| pos | Relative position of three-dimensional |
| | coordinates of the traffic obstruction |
| posConfidence | Position confidence of the traffic obstruction, |
| | including a longitude, a latitude, an elevation, |
| | and the like |
| speed | Speed of the traffic obstruction |
| speedCfd | Speed confidence of the traffic obstruction |
| heading | Clockwise included angle between a motion |
| | direction of the traffic obstruction and true north |
| headingCfd | Heading angle confidence of the traffic |
| | obstruction |
| size | Size of the traffic obstruction |
| objSizeConfidence | Size confidence |
| . . . | . . . |

The obsType field (sensing type), the pos field (sensing position), the speed field (sensing speed), the heading field (sensing heading angle), and the size field (sensing size) may represent the sensing object data of the traffic obstruction. The objTypeConfidence field (type confidence), the posConfidence field (position confidence), the objSizeConfidence field (size confidence), the speedCfd field (speed confidence), and the headingCfd field (heading angle confidence) may represent the sensing confidence of the traffic obstruction. The fields in Table 4 are not enumerated herein. For example, Table 4 may further include an obsId field (identifier of the traffic obstruction identified on the road side), a source field (source of traffic obstruction data), a secMark field (timestamp, millisecond-level moments within one minute), an accelSet field (four-axis acceleration of the traffic obstruction), and the like.

Table 5 shows a format of a signal status message and road side information according to some embodiments. Sensing object data and sensing confidence of a traffic event may be stored in the SSM message and the RSI message in Table 5. In other words, the sensing object data and sensing confidence of the traffic event in Table 5 may be used as either the SSM message or the RSI message. As shown in Table 5:

TABLE 5

| Field name | Descriptions |
|---|---|
| rteId | Identifier of the traffic event |
| eventType | Road traffic event type |
| eventSource | Source of road traffic event information |
| eventPos | Relative position of three-dimensional coordinates |
| | of the road traffic event |
| eventRadius | Radius size of the road traffic event |
| description | Description information of the road traffic event |
| timeDetails | Effective time of the road traffic event |
| priority | Priority of the road traffic event |
| referencePaths | Reference path of the road traffic event |
| referenceLinks | Reference link of the road traffic event |
| eventConfidence | Confidence of the road traffic event |
| . . . | . . . |

The rteId field, the eventType field, the eventSource field, the eventPos field, the eventRadius field, the description field, the timeDetails field, the priority field, the referencePaths field, and the referenceLinks field may represent the sensing object data (namely, a sensing event) of the traffic event, and the eventConfidence field (event confidence) may represent the sensing confidence of the traffic event. The fields in Table 5 are not enumerated herein.

S304: The on board terminal receives the road side sensing data and the baseline performance information sent by the road side communication device.

The road side sensing data is generated by a road side sensing device, the road side sensing device is located in a road side area covered by the road side communication device, the baseline performance information is configured for representing a sensing capability of the road side sensing device, the on board terminal is located in the road side area, and the baseline performance information is a capability that is for adjusting the road side sensing data and that is provided by the on board terminal. The on board terminal may include an on board communication device, where the on board terminal may receive the road side sensing data and the baseline performance information through the on board communication device.

FIG. 10A and FIG. 10B are schematic diagrams of scenarios of information exchange according to some embodiments. FIG. 10A and FIG. 10B are schematic diagrams of scenarios of interaction between a road side sensing device, a road side communication device, a vehicle side sensing device, and a vehicle side communication device. The road side sensing device and the road side communication device may be collectively referred to as a road side system, and the vehicle side sensing device and the vehicle side communication device may be collectively referred to as a vehicle side system. The road side sensing device may perform information interaction with the road side communication device, the road side communication device may perform information interaction with the vehicle side communication device, and the vehicle side communication device may perform information interaction with the vehicle side sensing device.

The process of information interaction between the road side system and the vehicle side system as shown in FIG. 10A and FIG. 10B may be understood as interaction between the vehicle and the infrastructure, for example the vehicle is the vehicle side system, and the infrastructure is the road side system. Information interacted between the vehicle side system and the road side system may be the foregoing road side sensing data and baseline performance information (namely, road side sensing baseline performance information).

S305: The on board terminal performs information verification on the baseline performance information, to obtain a verification result.

For a specific process in which the on board terminal verifies the baseline performance information, refer to the foregoing descriptions of operation S202 in the embodiment corresponding to FIG. 6, and this is not described herein again.

The on board terminal further includes a road side sensing confidence assessment module and a vehicle-road sensing fusion module. After receiving the road side sensing data and the baseline performance information, the on board communication device may send the road side sensing data and the baseline performance information to the road side sensing confidence assessment module, perform information verification on the baseline performance information by using the road side sensing confidence assessment module, where a confidence of the road side sensing data needs to be assessed in the verification process. Then, the on board communication device determines whether the road side sensing data needs to be adjusted, and sends the road side sensing data or adjusted road side sensing data to the vehicle-road sensing fusion module.

If the road side sensing data is adjusted, the on board terminal may determine to generate a verification result that the verification is not passed, and then perform the following operation S306; if the road side sensing data is not adjusted, the on board terminal may determine to generate a verification result that the verification is passed, and then perform the following operation S307.

S306: If the verification result indicates that the verification is not passed, the on board terminal performs a driving policy based on the adjusted road side sensing data.

The on board terminal may obtain vehicle side sensing data related to a vehicle side area. The on board terminal may obtain the vehicle side sensing data through the vehicle side sensing device. Further, if the road side sensing data is adjusted, the on board terminal may fuse the vehicle side sensing data and the adjusted road side sensing data, to obtain fused sensing data. When the on board terminal fuses the vehicle side sensing data and the adjusted road side sensing data, the data from different sensing devices may be fused in a plurality of methods such as early fusion, middle fusion, and late fusion (to be specific, fusion is performed when there is structured data). The vehicle side sensing data and the road side sensing data need to be fused in a V2X system. The vehicle-road sensing fusion in vehicle-road cooperation currently uses the late fusion method in view of the limitation of a communication channel width. There are many methods of late fusion, for example, Kalman filtering. In another embodiment, the vehicle side sensing data and the adjusted road side sensing data may alternatively be fused in a weighted summation method or the like, and this is not limited herein. Further, the on board terminal may perform the driving policy based on the fused sensing data. The fused sensing data herein may be referred to as first fused sensing data. In one embodiment, the on board terminal may alternatively perform the driving policy directly based on the adjusted road side sensing data without fusing the vehicle side sensing data and the adjusted road side sensing data.

The vehicle-road sensing fusion module may obtain the vehicle side sensing data sent by the vehicle side sensing device and the adjusted road side sensing data sent by the road side sensing confidence assessment module, and then fuse the vehicle side sensing data and the adjusted road side sensing data.

S307: If the verification result indicates that the verification is passed, the on board terminal performs a driving policy based on the road side sensing data.

The on board terminal may obtain vehicle side sensing data related to a vehicle side area. The on board terminal may obtain the vehicle side sensing data through the vehicle side sensing device. Further, if the road side sensing data is not adjusted, the on board terminal may fuse the vehicle side sensing data and the road side sensing data, to obtain fused sensing data. Further, the on board terminal may perform the driving policy based on the fused sensing data. The fused sensing data herein may be referred to as second fused sensing data. In one embodiment, the on board terminal may alternatively perform the driving policy directly based on the road side sensing data without fusing the vehicle side sensing data and the road side sensing data.

The vehicle-road sensing fusion module may obtain the vehicle side sensing data sent by the vehicle side sensing device and the road side sensing data sent by the road side sensing confidence assessment module, and then fuse the vehicle side sensing data and the road side sensing data.

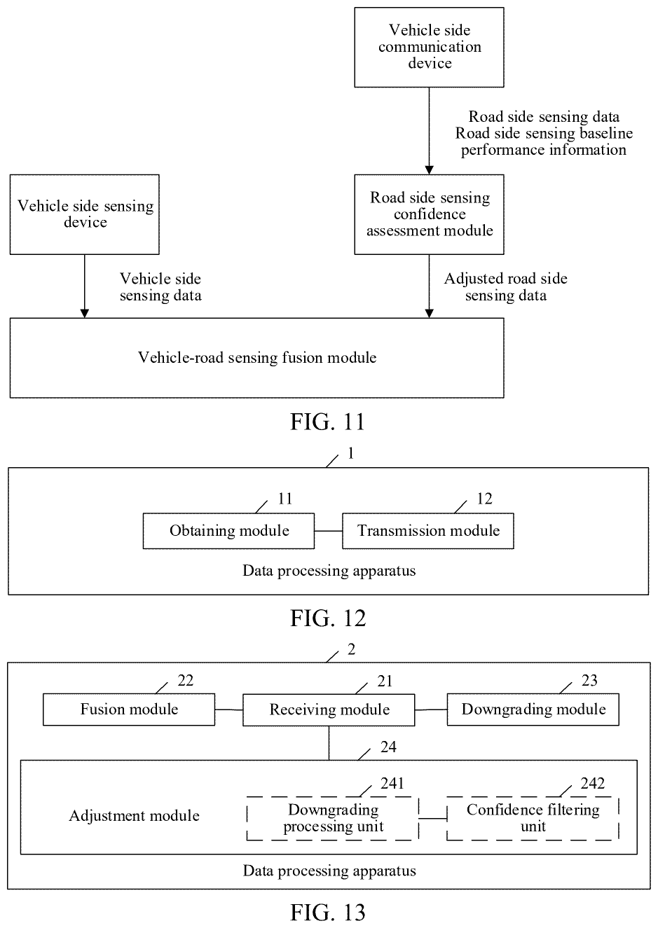

FIG. 11 is a schematic diagram of a scenario of data processing according to some embodiments. The on board terminal may include a vehicle side sensing device and an on board communication device, the on board terminal may further include a road side sensing confidence assessment module and a vehicle-road sensing fusion module. As shown in FIG. 11, the on board terminal may obtain on board sensing data through the on board sensing device, and obtain road side sensing data and road side sensing baseline performance information (namely, baseline performance information) through the on board communication device.

A vehicle factory corresponding to the on board terminal needs to take more responsibility for safe driving. Therefore, a sensing system of a vehicle (namely, the on board sensing device) is generally rigorously tested by the vehicle factory, so that the vehicle side sensing data generated by the vehicle side system is accurate. In terms of mechanism and costs, the road side system cannot be tested as required by the vehicle factory. Consequently, the road side sensing data generated by the road side system is inaccurate.

As shown in FIG. 11, the vehicle side communication device may send the road side sensing data and the baseline performance information to the road side sensing confidence assessment module. The road side sensing confidence assessment module may assess the road side sensing data and the baseline performance information, to generate adjusted road side sensing data. Further, the vehicle-road sensing fusion module may obtain the vehicle side sensing data sent by the vehicle side sensing device and the adjusted road side sensing data sent by the road side sensing confidence assessment module, and then fuse the vehicle side sensing data and the adjusted road side sensing data, to obtain first fused sensing data. In one embodiment, the road side sensing confidence assessment module may alternatively not need to adjust the road side sensing data when assessing the road side sensing data and the baseline performance information. Further, the vehicle-road sensing fusion module may obtain the vehicle side sensing data sent by the vehicle side sensing device and the road side sensing data sent by the road side sensing confidence assessment module, and then fuse the vehicle side sensing data and the road side sensing data, to obtain second fused sensing data.

Furthermore, because there may be a plurality of road side sensing devices, the on board terminal may receive road side sensing data, separately corresponding to a plurality of road side sensing devices, and baseline performance information, separately corresponding to a plurality of road side sensing devices, that are forwarded by the road side communication device. After performing the foregoing operations on the road side sensing data and the baseline performance information corresponding to each road side sensing device, the road side sensing data or adjusted road side sensing data corresponding to each road side sensing devices can be obtained, so that the on board terminal can fuse the vehicle side sensing data and the road side sensing data or adjusted road side sensing data corresponding to each road side sensing devices. For example, assuming that the number of the road side sensing devices is two, the two road side sensing devices may specifically include a road side sensing device S1 and a road side sensing device S2, baseline performance information of the road side sensing device S1 corresponds to a verification result that the verification is passed, and baseline performance information of the road side sensing device S2 corresponds to a verification result that the verification is not passed. Therefore, the on board terminal can fuse the road side sensing data of the road side sensing device S1, the adjusted road side sensing data of the road side sensing device S2, and the vehicle side sensing data.

The first fused sensing data or the second fused sensing data obtained through fusion can cause the on board terminal to perform a driving policy, where the driving policy indicates that the on board terminal can implement functions such as vehicle-road interworking, real-time traffic signal interaction, assisting drivers to drive, and safeguarding persons and vehicles in the entire traffic area.

It can be seen that according to the vehicle-road sensing baseline performance sharing method provided in some embodiments, the on board terminal can obtain the baseline performance information and the road side sensing data of the road side sensing device, make a more accurate assessment on the sensing confidence in the road side sensing data based on the baseline performance information, to realize adjustment of the road side sensing data. For the same sensing confidence, different road side sensing devices may generate different sensing object data. Therefore, adjusting the road side sensing data based on the baseline performance information can improve, when processing the adjusted road side sensing data, an accuracy of the processing result of the adjusted road side sensing data, in other words, improve an accuracy of the driving policy performed by the on board terminal. In addition, the vehicle side system can more efficiently fuse the adjusted road side sensing data and the vehicle side sensing data of the vehicle side sensing device, thereby improving the vehicle side system's trust in the road side sensing data of the road side system, and facilitating the vehicle-road cooperation application.

FIG. 12 is a schematic structural diagram of a data processing apparatus according to some embodiments. The data processing apparatus may be a computer program (including program code) running on a computer device. For example, the data processing apparatus is application software. The apparatus may be used to perform corresponding operations in the data processing method provided in some embodiments. As shown in FIG. 12, the data processing apparatus 1 may be used in a road side communication device, and the road side communication device may be the road side communication device 20a in the foregoing embodiment corresponding to FIG. 2. The data processing apparatus 1 may include an obtaining module 11 and a transmission module 12.

The obtaining module 11 is configured to obtain baseline performance information of a road side sensing device, where the baseline performance information is configured for representing a sensing capability of the road side sensing device, and the road side sensing device is located in a road side area covered by the road side communication device.

The baseline performance information is generated by the road side sensing device based on a test scenario provided by a certification authority; the baseline performance information includes at least one of test pass information, test certificate information, a test certification scenario, or a test certification level; the test pass information is configured for representing a test passing status of the road side sensing device; the test certificate information is configured for representing a certificate number provided by the certification authority for the road side sensing device; the test certification scenario is configured for representing the test scenario; and the test certification level is configured for representing the sensing capability of the road side sensing device in the test scenario.

The test certification level is determined by the certification authority based on a measured confidence of the road side sensing device; the measured confidence is determined by the certification authority based on target sensing data and test sensing data transmitted by the road side sensing device; the target sensing data is actual sensing data of a test object in the test scenario; and the test sensing data is sensing data of the test object sensed by the road side sensing device in the test scenario.

The obtaining module 11 is further configured to obtain road side sensing data generated by the road side sensing device.

The transmission module 12 is configured to transmit the road side sensing data and the baseline performance information to an on board terminal, so that the on board terminal adjusts the road side sensing data based on the baseline performance information, where the on board terminal is located in the road side area.

The obtaining module 11 is further configured to receive the baseline performance information transmitted by the road side sensing device.

The transmission module 12 is further configured to: generate a road side traffic message that carries the road side sensing data; add the baseline performance information to the road side traffic message, to obtain an updated road side traffic message; and transmit the updated road side traffic message to the on board terminal.

The updated road side traffic message includes a test pass field indicating the test pass information, a test certificate field indicating the test certificate information, a certification scenario field indicating the test certification scenario, and a certification level field indicating the test certification level.

For various implementations of the obtaining module 11 and the transmission module 12, refer to the descriptions of operations S101 and S102 in the foregoing embodiment corresponding to FIG. 3, and this is not described herein again. In addition, descriptions of beneficial effects of using the same method are not described herein again.

FIG. 13 is a schematic structural diagram of a data processing apparatus according to some embodiments. The data processing apparatus may be a computer program (including program code) running on a computer device. For example, the data processing apparatus is application software. The apparatus may be used to perform corresponding operations in the data processing method provided in some embodiments. As shown in FIG. 13, the data processing apparatus 2 may be used in an on board terminal, and the on board terminal may be the on board terminal 20b in the foregoing embodiment corresponding to FIG. 2. The data processing device 2 may include a receiving module 21 and a fusion module 22, and the data processing apparatus 2 may further include a downgrading module 23 and an adjustment module 24.

The receiving module 21 is configured to receive road side sensing data and baseline performance information transmitted by a road side communication device, where the road side sensing data is generated by a road side sensing device, the road side sensing device is located in a road side area covered by the road side communication device, the baseline performance information is configured for representing a sensing capability of the road side sensing device, and the on board terminal is located in the road side area.

The fusion module 22 is configured to: determine, based on the baseline performance information, whether to perform first adjustment processing on the road side sensing data; and if determining to perform the first adjustment processing on the road side sensing data, fuse vehicle side sensing data and adjusted road side sensing data, to obtain fused sensing data, where the fused sensing data is configured for performing a driving policy.

The baseline performance information is generated by the road side sensing device based on a test scenario provided by a certification authority; the baseline performance information includes at least one of test pass information, test certificate information, a test certification scenario, or a test certification level; the test pass information is configured for representing a test passing status of the road side sensing device; the test certificate information is configured for representing a certificate number provided by the certification authority for the road side sensing device; the test certification scenario is configured for representing the test scenario; and the test certification level is configured for representing the sensing capability of the road side sensing device in the test scenario.

In some embodiments, the downgrading module 23 is configured to downgrade the road side sensing data if the test pass information and the test certificate information indicate that the road side sensing device fails a test of the certification authority.

The road side sensing data includes a sensing confidence of a sensing object, and the sensing confidence includes at least one of an error confidence or a probability confidence.

The downgrading module 23 is further configured to increase an error value indicated by the error confidence if the road side sensing data includes the error confidence.

The downgrading module 23 is further configured to reduce a probability value indicated by the probability confidence if the road side sensing data includes the probability confidence.

The adjustment module 24 is configured to: if the test pass information and the test certificate information indicate that the road side sensing device passes a test of the certification authority, perform second adjustment processing on the road side sensing data based on the test certification scenario and the test certification level in the baseline performance information.

The adjusting module 24 includes a downgrading processing unit 241 and a confidence filtering unit 242.

The downgrading processing unit 241 is configured to: identify a driving scenario of the on board terminal, and if the test certification scenario does not include the driving scenario, downgrade the road side sensing data.

The confidence filtering unit 242 is configured to: if the test certification scenario includes the driving scenario, perform confidence filtering on the road side sensing data based on the test certification level.

The road side sensing data includes sensing object data and a sensing confidence of a sensing object, and the sensing object includes at least one of a traffic participant, a traffic obstruction, or a traffic event.

The confidence filtering unit 242 is further configured to: obtain an autonomous driving level corresponding to the on board terminal; and if the test certification level does not meet an autonomous driving condition indicated by the autonomous driving level, compare the sensing confidence of the sensing object with a confidence condition.

The confidence filtering unit 242 is further configured to: if the sensing confidence of the sensing object does not meet the confidence condition, delete the sensing object data and the sensing confidence of the sensing object from the road side sensing data.

If the sensing object includes the traffic participant, a sensing confidence of the traffic participant includes a position confidence, a speed confidence, a heading angle confidence, a size confidence, and a type confidence.

The confidence filtering unit 242 is further configured to: compare the position confidence of the traffic participant, the speed confidence of the traffic participant, the heading angle confidence of the traffic participant, the size confidence of the traffic participant, and the type confidence of the traffic participant with the confidence condition separately, and if the position confidence of the traffic participant, the speed confidence of the traffic participant, the heading angle confidence of the traffic participant, the size confidence of the traffic participant, or the type confidence of the traffic participant does not meet the confidence condition, determine that the sensing confidence of the traffic participant does not meet the confidence condition.

For implementations of the downgrading processing unit 241 and the confidence filtering unit 242, refer to the descriptions of operation S202 in the foregoing embodiment corresponding to FIG. 6, and this is not described herein again.

For implementations of the receiving module 21, the fusion module 22, the downgrading module 23, and the adjustment module 24, refer to the descriptions of operations S201 and S202 in the foregoing embodiment corresponding to FIG. 6, and this is not described herein again. In addition, descriptions of beneficial effects of using the same method are not described herein again.

A person skilled in the art would understand that these “modules” and “units” could be implemented by hardware logic, a processor or processors executing computer software code, or a combination of both. The “modules” and “units” may also be implemented in software stored in a memory of a computer or a non-transitory computer-readable medium, where the instructions of each module and unit are executable by a processor to thereby cause the processor to perform the respective operations of the corresponding module and unit.

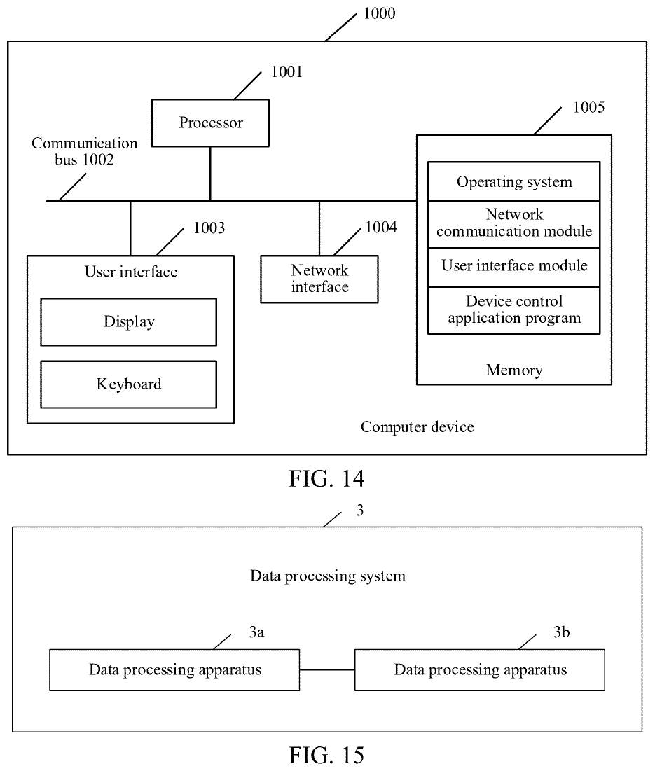

FIG. 14 is a schematic structural diagram of a computer device according to some embodiments. The computer device may be an on board terminal or a road side sensing device. As shown in FIG. 14, a computer device 1000 may include a processor 1001, a network interface 1004, and a memory 1005, and the computer device 1000 may further include a user interface 1003 and at least one communication bus 1002. The communication bus 1002 is configured to implement connection and communication between these components. In some embodiments, the user interface 1003 may include a display, a keyboard. In some embodiments, the user interface 1003 may further include a standard wired interface or wireless interface. In some embodiments, the network interface 1004 may include a standard wired interface or wireless interface (such as a Wi-Fi interface). The memory 1005 may be a high-speed RAM memory, or may be a non-volatile memory, such as at least one magnetic disk memory. In some embodiments, the memory 1005 may alternatively be at least one storage apparatus remotely located from the foregoing processor 1001. As shown in FIG. 14, the memory 1005, which is a type of computer-readable storage medium, may include an operating system, a network communication module, a user interface module, and a device control application program.

In the computer device 1000 shown in FIG. 14, the network interface 1004 may provide a network communication function; the user interface 1003 is mainly an interface configured for providing input for a user; and the processor 1001 may be configured to invoke the device control application program stored in the memory 1005.

The computer device 1000 according to some embodiments may implement the foregoing descriptions of the data processing method in the embodiment corresponding to FIG. 3, FIG. 6, or FIG. 9, or may implement the foregoing descriptions of the data processing apparatus 1 in the embodiment corresponding to FIG. 12 and the data processing apparatus 2 in the embodiment corresponding to FIG. 13, and this is not described herein again. In addition, descriptions of beneficial effects of using the same method are not described herein again.

In addition, some embodiments further provide a computer-readable storage medium, the computer-readable storage medium stores the computer program executed by the foregoing data processing apparatus 1 and data processing apparatus 2, and the computer program includes program instructions. When executing the program instructions, the processor can implement the foregoing descriptions of the data processing method in the embodiment corresponding to FIG. 3, FIG. 6, or FIG. 9. Therefore, this is not described herein again. In addition, descriptions of beneficial effects of using the same method are not described herein again. For technical details not disclosed in the embodiment of the computer-readable storage medium, refer to the descriptions of the method embodiments.

In addition, some embodiments further provide a computer program product or computer program. The computer program product or computer program may include computer instructions, and the computer instructions may be stored in a computer-readable storage medium. A processor of a computer device reads the computer instructions from the computer-readable storage medium, and the processor may execute the computer instructions, so that the computer device implements the foregoing descriptions of the data processing method in the embodiment corresponding to FIG. 3, FIG. 6, or FIG. 9. Therefore, this is not described herein again. In addition, descriptions of beneficial effects of using the same method are not described herein again. For technical details not disclosed in the embodiment of the computer program product or computer program, refer to the descriptions of the method embodiments.

FIG. 15 is a schematic structural diagram of a data processing system according to some embodiments. The data processing system 3 may include a data processing apparatus 3a and a data processing apparatus 3b. The data processing apparatus 3a may be the data processing apparatus 1 in the foregoing embodiment corresponding to FIG. 12. The data processing apparatus 3a may be integrated into the road side communication device 20a in the foregoing embodiment corresponding to FIG. 2, and therefore, this is not described herein again. The data processing apparatus 3b may be the data processing apparatus 2 in the foregoing embodiment corresponding to FIG. 13. The data processing apparatus 3b may be integrated into the on board terminal 20b in the foregoing embodiment corresponding to FIG. 2, and therefore, this is not described herein again. In addition, descriptions of beneficial effects of using the same method are not described herein again. For technical details not disclosed in the embodiment of the data processing system, refer to the descriptions of the method embodiments.

A person of ordinary skill in the art may understand that all or some of the processes of the methods in the embodiments may be implemented by a computer program instructing relevant hardware. The computer program may be stored in a computer-readable storage medium. When the program is executed, the procedures of the foregoing method embodiments may be performed. The storage medium may be a magnetic disk, an optical disc, a read-only memory (ROM), a random access memory (RAM), or the like.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A data processing method, performed by a computer device, comprising:
obtaining baseline performance information of a road side sensing device, the baseline performance information representing a sensing capability of the road side sensing device, and the road side sensing device being located in a road side area covered by the road side communication device;
obtaining road side sensing data generated by the road side sensing device; and
transmitting the road side sensing data and the baseline performance information to an on board terminal located in the road side area such that the on board terminal adjusts the road side sensing data based on the baseline performance information.

2. The data processing method according to claim 1, wherein the baseline performance information is generated by the road side sensing device based on a test scenario provided by a certification authority,
wherein the baseline performance information comprises a test certification level;
wherein the test certification level is configured for representing a level of the sensing capability of the road side sensing device in the test scenario.

3. The data processing method according to claim 2, wherein the test certification level is determined by the certification authority based on a measured confidence of the road side sensing device;
wherein the measured confidence is determined by the certification authority based on target sensing data and test sensing data transmitted by the road side sensing device; the target sensing data is actual sensing data of a test object in the test scenario; and the test sensing data is sensing data of the test object sensed by the road side sensing device in the test scenario.

4. The data processing method according to claim 2, wherein obtaining the baseline performance information comprises:
receiving the baseline performance information transmitted by the road side sensing device; and
wherein transmitting the road side sensing data and the baseline performance information comprises:
receiving a road side traffic message that is transmitted by the road side sensing device and that carries the road side sensing data,
adding the baseline performance information to the road side traffic message, to obtain an updated road side traffic message, and
transmitting the updated road side traffic message to the on board terminal.

5. The data processing method according to claim 4, wherein the updated road side traffic message comprises a certification level field indicating the test certification level.

6. The data processing method according to claim 1, wherein the baseline performance information comprises at least one of test pass information, test certificate information, or a test certification scenario;
wherein the test pass information is configured for representing a test passing status of the road side sensing device;
wherein the test certificate information is configured for representing a certificate number provided by the certification authority for the road side sensing device; and
wherein the test certification scenario is configured for representing the test scenario.

7. The data processing method according to claim 6, wherein the updated road side traffic message comprises a test pass field indicating the test pass information, a test certificate field indicating the test certificate information, and a certification scenario field indicating the test certification scenario.

8. A data processing apparatus comprising:
at least one memory configured to store program code; and
at least one processor configured to read the program code and operate as instructed by the program code, the program code comprising:
obtaining code configured to cause at least one of the at least one processor to:
obtain baseline performance information of a road side sensing device, the baseline performance information representing a sensing capability of the road side sensing device, and the road side sensing device being located in a road side area covered by a road side communication device, and
obtain road side sensing data generated by the road side sensing device; and
transmission code configured to cause at least one of the at least one processor to transmit the road side sensing data and the baseline performance information to an on board terminal located in the road side area such that the on board terminal adjusts the road side sensing data based on the baseline performance information.

9. The data processing apparatus according to claim 8, wherein the baseline performance information is generated by the road side sensing device based on a test scenario provided by a certification authority,
wherein the baseline performance information comprises a test certification level;
wherein the test certification level is configured for representing a level of the sensing capability of the road side sensing device in the test scenario.

10. The data processing apparatus according to claim 9, wherein the test certification level is determined by the certification authority based on a measured confidence of the road side sensing device;
wherein the measured confidence is determined by the certification authority based on target sensing data and test sensing data transmitted by the road side sensing device; the target sensing data is actual sensing data of a test object in the test scenario; and the test sensing data is sensing data of the test object sensed by the road side sensing device in the test scenario.

11. The data processing apparatus according to claim 9, wherein the obtaining code is further configured to cause at least one of the at least one processor to:
receive the baseline performance information transmitted by the road side sensing device; and
wherein the transmitting code is further configured to cause at least one of the at least one professor to:
receive a road side traffic message that is transmitted by the road side sensing device and that carries the road side sensing data,
add the baseline performance information to the road side traffic message, to obtain an updated road side traffic message, and
transmit the updated road side traffic message to the on board terminal.

12. The data processing apparatus according to claim 11, wherein the updated road side traffic message comprises a certification level field indicating the test certification level.

13. The data processing apparatus according to claim 8, wherein the baseline performance information comprises at least one of test pass information, test certificate information, or a test certification scenario;
wherein the test pass information is configured for representing a test passing status of the road side sensing device;
wherein the test certificate information is configured for representing a certificate number provided by the certification authority for the road side sensing device; and
wherein the test certification scenario is configured for representing the test scenario.

14. The data processing apparatus according to claim 13, wherein the updated road side traffic message comprises: a test pass field indicating the test pass information, a test certificate field indicating the test certificate information, and a certification scenario field indicating the test certification scenario.

15. A non-transitory computer-readable storage medium storing computer code which, when executed by at least one processor, causes the at least one processor to at least:
obtain baseline performance information of a road side sensing device, the baseline performance information representing a sensing capability of the road side sensing device, and the road side sensing device being located in a road side area covered by the road side communication device;
obtain road side sensing data generated by the road side sensing device; and
transmit the road side sensing data and the baseline performance information to an on board terminal located in the road side area such that the on board terminal adjusts the road side sensing data based on the baseline performance information.

16. The non-transitory computer-readable storage medium according to claim 15, wherein the baseline performance information is generated by the road side sensing device based on a test scenario provided by a certification authority,
wherein the baseline performance information comprises a test certification level;
wherein the test certification level is configured for representing a level of the sensing capability of the road side sensing device in the test scenario.

17. The non-transitory computer-readable storage medium according to claim 16, wherein the test certification level is determined by the certification authority based on a measured confidence of the road side sensing device;
wherein the measured confidence is determined by the certification authority based on target sensing data and test sensing data transmitted by the road side sensing device; the target sensing data is actual sensing data of a test object in the test scenario; and the test sensing data is sensing data of the test object sensed by the road side sensing device in the test scenario.

18. The non-transitory computer-readable storage medium according to claim 16, wherein the obtain the baseline performance information comprises:
receiving the baseline performance information transmitted by the road side sensing device; and
wherein the transmit the road side sensing data and the baseline performance information comprises:
receiving a road side traffic message that is transmitted by the road side sensing device and that carries the road side sensing data,
adding the baseline performance information to the road side traffic message, to obtain an updated road side traffic message, and
transmitting the updated road side traffic message to the on board terminal.

19. The non-transitory computer-readable storage medium according to claim 18, wherein the updated road side traffic message comprises a certification level field indicating the test certification level.

20. The non-transitory computer-readable storage medium according to claim 15, wherein the baseline performance information comprises at least one of test pass information, test certificate information, or a test certification scenario;
wherein the test pass information is configured for representing a test passing status of the road side sensing device;
wherein the test certificate information is configured for representing a certificate number provided by the certification authority for the road side sensing device; and
wherein the test certification scenario is configured for representing the test scenario.
